(19) United States
(12) Patent Application Publication
(10) Pub. No.: US 2026/0288817 A1
(43) Pub. Date: Sep. 24, 2026

(54) SYSTEM

(71) Applicant: SoftBank Group Corp., Tokyo (JP)

(72) Inventor: Hiroyuki YAMAUCHI, Tokyo (JP)

(73) Assignee: SoftBank Group Corp., Tokyo (JP)

(21) Appl. No.: 19/567,367

(22) Filed: Mar. 16, 2026

(30) Foreign Application Priority Data
Mar. 19, 2025 (JP) 2025-045116

(51) Int. Cl. G06F 16/3329; G06F 16/215; G06F 40/169; G06F 40/226; G06F 40/295

(52) U.S. Cl. CPC G06F 16/33295; G06F 16/215; G06F 40/169; G06F 40/226; G06F 40/295

(57) ABSTRACT

A system includes a processor that is configured to collect documents, records, and data relating to individual business operations, extract individual experience values, know-how, findings, and tacit senses from the collected data by using a natural language processing technique, and input the extracted information into a generative AI model and generate a prompt that instructs the generative AI model to discover unexpected findings.

### CROSS-REFERENCE TO RELATED APPLICATION

This application is based on and claims priority under 35 USC 119 from Japanese Patent Application No. 2025-045116 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In conventional business support systems, large amounts of documents, records, and data related to individual business operations are stored in various information systems, but the individual experience values, know-how, findings, and tacit senses of employees that are implicitly embedded in such data are not effectively extracted or utilized. As a result, organizations fail to systematically discover unexpected findings or latent insights that could contribute to problem solving, business improvement, or innovation. Furthermore, conventional systems typically do not take into account the emotional state of users when performing AI analysis or generating proposals, and therefore cannot provide outputs that are adapted to the user's current psychological condition. In particular, there is a problem that conventional systems are unable to generate prompts to generative AI models that both leverage internal experiential knowledge and reflect the user's emotional state, so that optimal products or services tailored to the user's situation cannot be proposed in a timely and appropriate manner.

### SUMMARY

In order to solve the above problems, a system according to one aspect of the present invention comprises a processor, wherein the processor is configured to collect documents, records, and data relating to individual business operations, extract individual experience values, know-how, findings, and tacit senses from the collected data by using a natural language processing technique, and input the extracted information into a generative AI model and generate a prompt that instructs the generative AI model to discover unexpected findings. According to another aspect, the processor is configured to recognize an emotional state of a user by using a sensor device and feed back information on the emotional state to AI analysis, thereby enabling the analysis and generation process to consider the user's psychological context. According to still another aspect, the processor is configured to generate a prompt that instructs the generative AI model to propose an optimal product or service based on the emotional state of the user, so that proposals output by the generative AI model can be appropriately personalized and aligned with both the extracted experiential knowledge within the organization and the current emotional state of the user.

The term “documents, records, and data” refers to electronic or digital information items stored in one or more information systems, including but not limited to text documents, logs, reports, messages, database entries, and structured or unstructured data that describe or relate to business activities.

The term “individual business operations” refers to specific tasks, processes, workflows, projects, or activities performed by one or more persons or systems within an organization in the course of conducting business.

The term “experience values” refers to information indicative of practical knowledge obtained through past actions or operations, including outcomes, lessons learned, effective practices, and performance patterns accumulated by individuals in the course of business operations.

The term “know-how” refers to concrete procedural knowledge or techniques regarding how to perform a task or solve a problem, including specific methods, steps, tips, and rules that are used in business operations.

The term “findings” refers to insights, conclusions, or discoveries derived from observation, analysis, or experience in the context of business operations, including recognition of causes, correlations, or improvement opportunities.

The term “tacit senses” refers to implicit or subjective perceptions, intuitions, feelings, or gut-level judgments held by individuals regarding business operations, which may not be explicitly described but can be inferred from language, behavior, or contextual information.

The term “natural language processing technique” refers to any computational method or algorithm for analyzing, understanding, or processing human language text, including but not limited to tokenization, part-of-speech tagging, semantic analysis, named entity recognition, summarization, and topic extraction.

The term “generative AI model” refers to a machine learning model or artificial intelligence model that generates text or other content in response to input data or prompts, including but not limited to large language models and transformer-based generative models.

The term “prompt” refers to a text or data structure provided as input to a generative AI model, the content of which instructs or guides the generative AI model regarding a desired output, such as a type of analysis, a style of response, or a kind of proposal.

The term “unexpected findings” refers to insights, patterns, relationships, or knowledge items discovered by the generative AI model that are not readily apparent, predicted, or explicitly known to the user or organization prior to analysis.

The term “sensor device” refers to any hardware device capable of detecting or measuring information related to a user, including but not limited to wearable sensors, cameras, microphones, physiological sensors, and environmental sensors, and outputting corresponding digital signals.

The term “emotional state of a user” refers to a psychological or affective condition of the user, such as stress, satisfaction, frustration, excitement, or calmness, inferred from sensor data, behavioral data, or other observable signals.

The term “AI analysis” refers to processing performed by one or more artificial intelligence algorithms or models, including the use of machine learning, statistical models, or generative AI models, to extract features, recognize patterns, evaluate conditions, or produce inferences based on input data.

The term “optimal product or service” refers to a product or service selected or generated as being suitable or preferable for the user under given conditions, taking into account at least the user's emotional state and, optionally, other constraints such as user preferences, context, or business rules.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

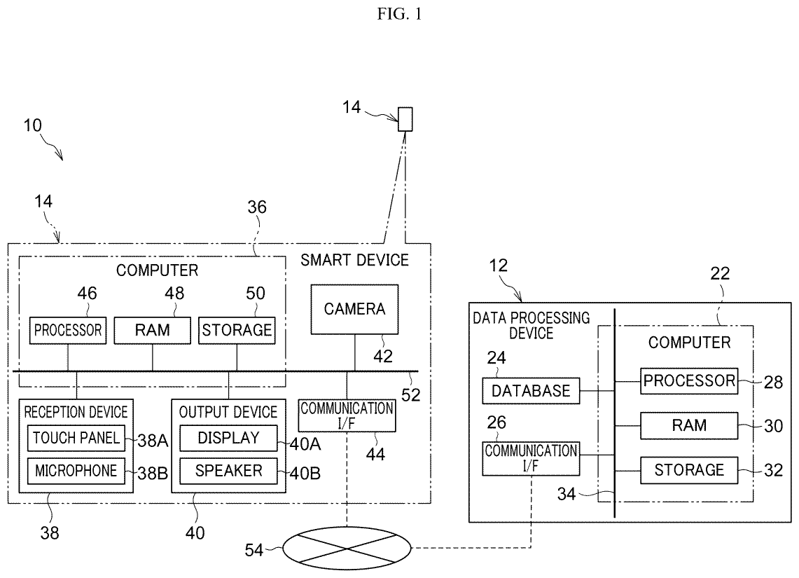

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

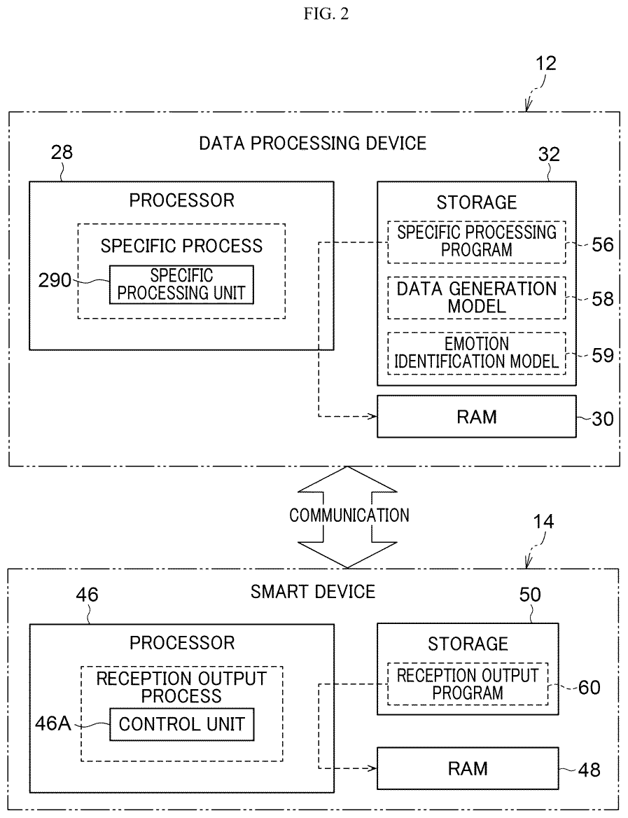

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### EXAMPLE 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented analytics systems that process business-related data typically rely on fixed reporting logic, static rule sets, or predefined dashboards. Such systems mainly aggregate numerical indicators and generate template-based summaries, without deeply integrating unstructured data such as textual descriptions, reports, and feedback with structured quantitative records. As a result, the systems are limited to surface-level correlations and are unable to computationally derive latent patterns, success factors, and risk factors embedded in heterogeneous enterprise data.

In many existing architectures, unstructured text is either ignored or reduced to simple keyword counts, and there is no end-to-end technical mechanism that integrates natural language processing, machine learning-based clustering, and generative AI models into a single coordinated workflow. In particular, conventional systems do not generate machine-readable analytical structures that can be directly consumed as context for a generative AI model through a prompt sentence, nor do they dynamically adapt the analytical pipeline and prompts in response to changing user-specified analysis conditions. This leads to inefficiencies, such as redundant manual analysis, ad hoc data extraction, and fragmented toolchains that require human intermediaries to interpret intermediate results and craft suitable model inputs.

Furthermore, many existing systems treat the generative AI model as an isolated component that simply receives free-form user prompts. They do not provide a systematic computational method to derive structured pattern information and trend information from the underlying data, transform that information into optimized prompt sentences, and iteratively refine both the data subsets and the prompts based on user instructions. Consequently, the quality, reproducibility, and explainability of the generated natural-language insights depend heavily on the user's manual prompt engineering skills rather than on an improved computer-implemented analysis pipeline.

Accordingly, there is a need for a computer technology that improves how processors acquire and preprocess heterogeneous business-related data, how they automatically derive feature matrices and cluster structures, how they convert such analytical structures into machine-consumable prompts, and how they orchestrate interactions with a generative AI model to obtain consistent, high-quality natural-language reports. There is also a need for a system that enables dynamic re-analysis by programmatically modifying both the clustering target set and the prompt content in response to user-specified analysis conditions and viewpoints, thereby improving the overall efficiency, scalability, and technical robustness of data-driven knowledge discovery in enterprise environments.

The specific processing by the specific processing unit 290 of the data processing device 12 in Example 1 is realized by the following means.

The present invention provides a server comprising a processor configured to acquire structured data and unstructured data from a plurality of information sources including business-related information, to normalize and preprocess the acquired data, to perform natural language processing on the preprocessed unstructured data to extract keywords and phrases indicating experiential information and knowledge information related to execution of business tasks, to generate a feature matrix based on the extracted keywords and phrases and quantitative information included in the structured data, to perform clustering processing on the feature matrix by using a machine learning algorithm to derive pattern information and trend information correlated with outcomes of the business tasks, to generate structured analysis results including novel insight information indicating success factors and risk factors of the business tasks from the pattern information and the trend information, to construct a prompt sentence that, by using the structured analysis results as input data, instructs a generative AI model to generate, in a natural language, at least one of a summary of the analysis results, an explanation of causal relationships, and proposals for improvement of the business tasks, to input the prompt sentence into the generative AI model, to obtain a report sentence in the natural language output from the generative AI model, and to generate report information that is configured to be output to a user terminal based on the report sentence, and further configured to receive instruction information including analysis conditions and analysis viewpoints from a user, to dynamically change content of the prompt sentence and a target data set for the clustering processing based on the instruction information, and to perform re-analysis by regenerating the prompt sentence and re-invoking the generative AI model based on updated analysis conditions. This enables an improved computer-implemented analysis pipeline that automatically integrates heterogeneous data acquisition, feature construction, clustering-based pattern discovery, and generative AI-based report generation, while programmatically optimizing prompt sentences and target data sets in response to user-specified analysis parameters, thereby enhancing the efficiency, consistency, and technical quality of natural-language insight generation in enterprise information processing systems.

The term “processor” refers to a hardware information processing unit, such as a central processing unit or an execution core, that is configured to execute instructions of a program to perform data acquisition, data processing, machine learning, and control of interactions with other components of the system.

The term “structured data” refers to information that is organized according to a predefined schema, such as tabular records, fields, and numerical values in a database or data table, which can be directly processed using relational operations or numerical computations.

The term “unstructured data” refers to information that does not follow a predefined schema, such as free-form text, narrative descriptions, messages, or other content that requires natural language processing or similar techniques to be analyzed computationally.

The term “information source” refers to an electronic system, storage medium, or communication interface from which data is acquired, including but not limited to databases, business management systems, project management systems, and file storage systems.

The term “normalize” refers to processing that converts heterogeneous data into a consistent representation, including unifying formats, data types, categories, and value ranges so that subsequent computational processing can be performed in a standardized manner.

The term “preprocess” refers to a set of operations applied to raw data before main analysis, including at least cleaning, filtering, type conversion, tokenization, and other transformations that prepare the data for natural language processing and machine learning.

The term “natural language processing” refers to computational techniques and algorithms that analyze and transform natural language text, including morphological analysis, tokenization, part-of-speech tagging, phrase extraction, and related operations.

The term “keyword” refers to a term or token, typically a word or short expression obtained by natural language processing, that represents an important concept, feature, or topic related to execution of business tasks.

The term “phrase” refers to a multi-word linguistic unit, such as a noun phrase or verb phrase, that is extracted from text and used to represent a composite concept or relationship relevant to business tasks.

The term “experiential information” refers to information derived from human or organizational experience in executing business tasks, including informal observations, practical know-how, lessons learned, and other non-formalized knowledge that can be inferred from text.

The term “knowledge information” refers to information expressing relationships, patterns, or principles about business tasks, including domain knowledge, procedural knowledge, and conceptual structures that can be extracted from data.

The term “feature matrix” refers to a numerical data structure, typically represented as a two-dimensional array, in which each row corresponds to an analysis target such as a business case and each column corresponds to a feature value derived from keywords, phrases, or quantitative data.

The term “quantitative information” refers to numerical values associated with business tasks, such as performance indicators, durations, amounts, scores, or other measurable attributes that can be used in computational analysis.

The term “machine learning algorithm” refers to a computational method that automatically learns patterns or structures from data, including at least clustering algorithms, classification algorithms, or regression algorithms used to discover relationships in the feature matrix.

The term “clustering processing” refers to machine learning-based processing that groups analysis targets into clusters based on similarity of feature values, thereby identifying subsets of business tasks that share similar characteristics.

The term “pattern information” refers to information representing characteristic combinations of features discovered by clustering processing, including typical attribute values, frequent keywords, and common behaviors within a cluster.

The term “trend information” refers to information representing directional or temporal tendencies observed across multiple business tasks or clusters, such as increasing or decreasing performance metrics, frequent co-occurrences, or correlated changes in attributes.

The term “outcome” refers to a result or performance state of a business task, including but not limited to success, failure, quality level, satisfaction level, or other evaluative indicators.

The term “structured analysis results” refers to data structures that encode outputs of the analysis pipeline in a machine-readable format, including identifiers of clusters, associated pattern information, trend information, success factors, and risk factors.

The term “novel insight information” refers to analysis-derived information that reveals previously unrecognized or non-obvious success factors, risk factors, or patterns related to business tasks, obtained through computational processing of the feature matrix and clustering results.

The term “success factor” refers to a condition, attribute, or practice that correlates with desirable outcomes of business tasks, such as high performance, efficiency, or satisfaction, as identified through the analysis.

The term “risk factor” refers to a condition, attribute, or practice that correlates with undesirable outcomes of business tasks, such as failure, delay, or low satisfaction, as identified through the analysis.

The term “prompt sentence” refers to a machine-generated or machine-constructed natural language instruction or input text that is designed to be provided to a generative AI model and that specifies a task, context, or constraints for generating a natural language output.

The term “generative AI model” refers to a computational model, such as a large language model, that is trained to generate natural language text in response to input data including prompt sentences and structured analysis results.

The term “report sentence” refers to a unit of natural language text output by the generative AI model, which describes analysis results, explanations, or recommendations related to business tasks.

The term “report information” refers to a set of data that includes at least one report sentence formatted or arranged for presentation to a user, for example as a document, screen display, or message that can be output from the system.

The term “user terminal” refers to an electronic device operated by a user, such as a workstation, portable information device, or communication terminal, that is configured to send analysis instructions to the server and receive and present report information.

The term “instruction information” refers to input data received from a user that specifies at least analysis conditions and analysis viewpoints, including filters, target groups, time ranges, or preferred focuses for the computational analysis.

The term “analysis condition” refers to a constraint or parameter that defines a scope or method of analysis, such as a subset of data, a time period, a business category, or a selection of metrics to be considered.

The term “analysis viewpoint” refers to a conceptual or interpretive focus specified by a user, such as an emphasis on communication, cost efficiency, risk reduction, or customer satisfaction in the generated analysis.

The term “target data set” refers to a subset of the overall acquired data that is selected for clustering processing and subsequent analysis based on specified analysis conditions and viewpoints.

The term “re-analysis” refers to a subsequent analysis operation in which at least one of the target data set, feature matrix, clustering processing, or prompt sentence is modified based on updated instruction information, and the generative AI model is invoked again to generate new or refined report information.

The term “business task” refers to an operational activity, process, or project executed within an organization, including but not limited to development activities, service provision, internal operations, and other enterprise functions subject to analysis.

In one embodiment, a server includes at least one processor, a main memory, a non-volatile storage device, and a communication interface coupled via a bus. The server executes a program stored in the non-volatile storage device to implement the functions described below. The program may be implemented in a high-level programming language such as Python running on an operating system. The server communicates with at least one terminal operated by a user via a network such as a local area network or a wide area network.

The server acquires structured data and unstructured data from multiple information sources. The server connects to one or more database management systems, such as a relational database engine, via a database driver. The server also connects to one or more business management applications or project management applications via an application programming interface. The server receives, through these interfaces, records including identifiers, numeric performance indicators, time stamps, and text fields such as descriptions and feedback. The server stores the acquired data in a working data structure in main memory, for example, as a table-like structure corresponding to a data frame.

The server normalizes and preprocesses the acquired data. The server uses a data manipulation library, such as a tabular data processing library, to convert raw values into standardized formats. The server converts date strings into time objects, converts numeric strings into integers or floating-point numbers, and maps heterogeneous category labels into unified internal codes. The server performs missing value handling by applying predetermined rules, such as discarding incomplete rows when critical fields are absent or imputing missing numeric values with a median or mean computed per column.

The server applies natural language processing to the unstructured text fields. The server uses a natural language processing library, such as a tokenization and parsing toolkit, to segment each text into tokens, assign part-of-speech tags, and detect phrases such as noun phrases. The server may apply lemmatization or stemming to normalize word forms. The server removes stop words by referring to a stop-word list stored in the memory. The server constructs a cleaned text representation, which concatenates tokens relevant to experiential information and knowledge information. This cleaned text is stored in an additional column of the working data structure.

The server generates features from the preprocessed data. For text, the server uses a feature extraction library, such as a TF-IDF vectorization module, to convert cleaned text into a numeric representation. The server controls parameters such as maximum vocabulary size, minimum document frequency, and n-gram length, to limit the dimensionality of the feature space and suppress noise. For structured data, the server extracts numeric attributes such as durations, amounts, counts, and scores. The server applies a scaling module, such as a standardization or min-max normalization module, to rescale these numeric attributes so that each attribute contributes comparably to subsequent distance calculations. The server concatenates the text-derived features and the scaled numeric attributes into a feature matrix in which each row corresponds to a subject of analysis, such as a project instance, and each column corresponds to a feature.

The server performs clustering on the feature matrix. The server uses a machine learning library, such as a clustering algorithm implementation, to partition the feature vectors into clusters. In one embodiment, the server applies a centroid-based clustering algorithm that initializes a set of cluster centroids and iteratively updates them. The server computes distances, such as Euclidean distances, between data points and centroids, assigns each data point to its nearest centroid, and recomputes centroids as the mean of assigned points. The server repeats this process until convergence criteria, such as a maximum number of iterations or a minimum change in centroids, are satisfied. The server may determine the number of clusters by computing quality metrics, such as a silhouette coefficient, over candidate numbers of clusters.

The server derives pattern information and trend information from the clustering results. The server associates each data point with a cluster identifier and aggregates statistics per cluster. The server computes, for each cluster, average values of outcome-related indicators, dispersion metrics, and distributions of categorical attributes. The server also computes, for each text feature, an average TF-IDF weight within the cluster and identifies the highest weighted terms and phrases as representative keywords. The server stores, per cluster, a set of representative keywords, representative attribute ranges, and representative outcome values. The server further analyzes differences between clusters to detect trends, such as clusters with systematically higher scores or shorter durations compared to others.

The server generates structured analysis results from the pattern information and trend information. The server constructs a data structure that, for each cluster, includes at least a cluster identifier, a list of representative keywords, summary statistics of numeric attributes, and indicators of success factors and risk factors. The server may mark attributes as potential success factors when they are significantly associated with favorable outcomes, according to predefined criteria such as thresholds on means, differences, or correlation coefficients. The server may similarly mark attributes as potential risk factors when they are associated with unfavorable outcomes. The server stores these structured analysis results in a machine-readable form, for example as key-value pairs, arrays, and lists.

The server constructs a prompt sentence for a generative AI model by using the structured analysis results. The server formats a natural language instruction that clearly describes the task to be performed by the generative AI model. The server embeds summaries of the cluster structures, representative keywords, and key metrics into the prompt sentence, thereby providing precise context. The server may generate a prompt sentence of the following form: “Analyze the following clustered business task data and generate a structured report.
Cluster 1: high satisfaction score, short duration, keywords: ‘frequent status meetings’, ‘transparent communication’, ‘on-time delivery’.
Cluster 2: low satisfaction score, long duration, keywords: ‘delivery delay’, ‘scope change’, ‘resource shortage’.

Explain the main success factors and risk factors, and propose at least three concrete recommendations for improving future business tasks.”

The server sends the constructed prompt sentence to a generative AI model via a network interface. The generative AI model may be deployed on the same server, on another computing device, or as an external service accessible through a communication interface. In one embodiment, the generative AI model is implemented as a neural network-based language model, for example a transformer architecture comprising a plurality of self-attention layers, feed-forward layers, and normalization layers. The model parameters are stored in a model storage medium and loaded into memory when the model is invoked.

The server controls the generative AI model by specifying configuration parameters such as maximum output length, sampling temperature, and stopping conditions. The server provides the prompt sentence as input tokens to the neural network. The generative AI model processes the tokens through multiple layers, where each layer computes attention weights and linear transformations using stored weight matrices and bias vectors. During generation, the model outputs probability distributions over possible next tokens. The server selects tokens based on these distributions according to a decoding strategy, such as greedy selection, beam search, or probabilistic sampling, until an end-of-sequence token is emitted or a maximum length is reached. The output sequence forms a report sentence or a set of sentences.

The server obtains the generated report sentence from the generative AI model and converts it into report information suitable for presentation on the terminal. The server may segment the generated text into sections, insert headings, and transform bullet-like content into a standardized layout. The server then transmits the report information to the terminal via the communication interface.

The terminal includes a processor, a display device, an input device, and a communication module. The terminal receives the report information from the server, renders it on the display, and allows the user to scroll, search, or otherwise interact with the content. The terminal also enables the user to specify analysis conditions and analysis viewpoints, such as filters on time period, business category, or focus on specific aspects like communication or cost. The terminal transmits these user inputs as instruction information to the server.

The server receives the instruction information and adjusts subsequent processing accordingly. The server may filter the source data to form a new target data set that matches a specified time range, domain, or outcome threshold. The server may also modify parameters of the feature extraction, such as adapting the vocabulary to emphasize terms related to the specified analysis viewpoint. Furthermore, the server regenerates the prompt sentence to reflect the updated focus. For example, when the user requests emphasis on communication patterns, the server may construct a prompt sentence as follows:

“Based on the clustered business task data, focus specifically on communication-related patterns that affect satisfaction scores.

Describe how communication practices differ between high-performing and low-performing clusters, and propose concrete improvements to communication processes.”

The server re-invokes the generative AI model with the updated prompt sentence and, if necessary, updated structured analysis results. The iterative re-analysis is performed automatically by the server, without requiring the user to craft detailed prompts manually. This automated adjustment of both target data and prompt content constitutes more than a simple automation of human tasks; it changes the way the computer processes and structures information before interacting with the generative AI model.

The server achieves technical improvements in several aspects. First, by generating and operating on the unified feature matrix, the server reduces redundant data passes and enables efficient in-memory clustering, which improves processing speed. The integration of structured and unstructured features in a single matrix allows the distance computations in the clustering algorithm to exploit more complete information, improving the quality of clusters and reducing misclassification errors compared to treating text and numeric data separately. Second, the server's use of explicit cluster-based summaries and structured analysis results optimizes the prompt content for the generative AI model, thereby improving the stability and reproducibility of output, and reducing the need to transmit large volumes of raw data over the network. This reduces communication load and improves response times.

Furthermore, the server's pipeline differs from conventional human analysis in that the server uses non-heuristic numerical criteria to determine clusters, success factors, and risk factors, rather than relying on ad hoc human judgment. For example, the server can compute correlation coefficients, measure effect sizes between clusters, and use predefined statistical thresholds to systematically select candidate factors. These computationally defined rules ensure that the system behaves consistently even as data volume grows, and they enable scalable operation that would be impractical for human analysts.

In some embodiments, the generative AI model is trained or fine-tuned using domain-specific analysis examples. The server may store training data consisting of input prompt sentences and desired report outputs. During training, a training module on the server or on another device computes a loss function, such as cross-entropy between predicted tokens and ground-truth tokens, and updates the model's weight parameters by gradient-based optimization, such as stochastic gradient descent or an adaptive learning rate method. The training process may incorporate regularization techniques and data augmentation, such as paraphrasing or reordering of sections, to improve the model's ability to generalize. By describing and implementing these learning methods, the system provides a technical structure for improving the internal representation learned by the neural network, leading to more accurate and coherent report generation.

The server improves data management by maintaining a clear separation between raw data, feature representations, cluster assignments, and structured analysis results as distinct data structures. This modularization allows the server to reuse intermediate results, avoiding repeated computation when similar analysis conditions are requested. For example, when only the analysis viewpoint changes but the underlying data subset remains constant, the server can bypass the acquisition and clustering stages and regenerate only the prompt sentence and generative model invocation. This contributes to computational efficiency and reduces energy consumption.

In one variation, the server uses alternative clustering algorithms, such as density-based clustering or hierarchical clustering, when data characteristics or user requirements indicate that non-spherical clusters or nested structures are preferable. The server selects or switches algorithms by evaluating internal quality measures stored in memory. The use of multiple algorithmic options and their programmatic selection improves robustness and adaptability compared to a single fixed algorithm.

In another variation, the server may integrate additional feature types, such as graph-based features that represent relations between entities involved in business tasks. The server can build adjacency matrices representing co-occurrence or dependency relations and compute embeddings using dedicated algorithms. These graph-based features can then be concatenated with existing features in the feature matrix. This extension allows the system to capture structural patterns not observable in independent records.

The terminal and the user cooperate with the server to operate the system. The user interacts with the terminal to specify analysis conditions, interpret reports, and request refinements. The terminal translates these interactions into machine-readable instruction information. The server processes this information to reconfigure its internal operations, thereby enabling adaptive computer behavior not present in static reporting tools.

Through these configurations, the system as a whole provides a concrete implementation that improves computer technology: it integrates heterogeneous data into a unified feature representation, applies machine learning to derive clusters and patterns, constructs optimized prompt sentences based on structured analysis results, and orchestrates a generative AI model to produce high-quality natural-language reports. The server achieves improved processing speed, analytical accuracy, reproducibility, and reduced communication load, and enables technically meaningful re-analysis workflows that go beyond mere automation of human reasoning.

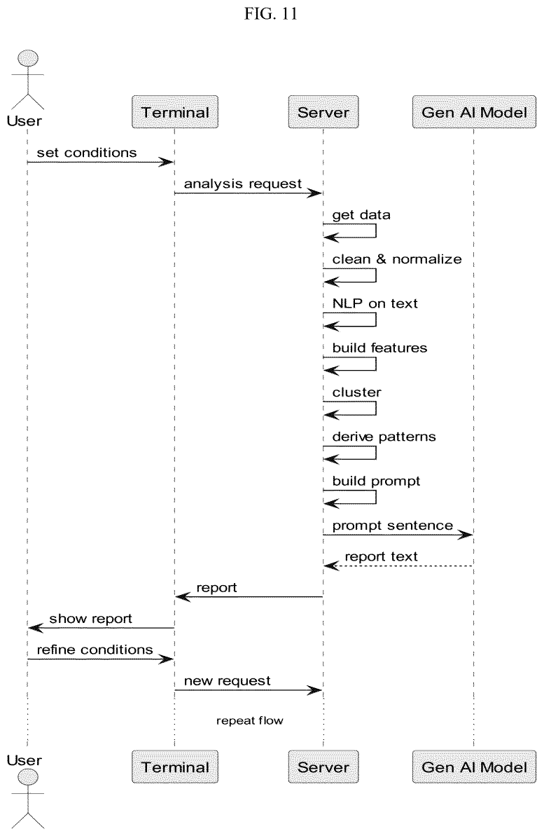

The following describes the processing flow using FIG. 11.

### Step 1:

The terminal sends an analysis request to the server.

The user operates the terminal to select a business domain, a time range, and an analysis viewpoint (for example, “project success factors” or “communication patterns”). The terminal converts these selections into instruction information including analysis conditions and analysis viewpoints, and transmits the instruction information to the server via a communication interface.

Input: user-specified analysis conditions and analysis viewpoints.

Output: a structured instruction message delivered from the terminal to the server.

### Step 2:

The server acquires raw data from multiple information sources.

The server receives the instruction message and, based on the analysis conditions, constructs database queries and API requests. The server sends the queries to at least one database system and receives structured records including identifiers, numeric attributes, time stamps, and text fields. The server also sends API requests to at least one business management system and receives additional structured and unstructured data. The server loads the responses into memory and stores them in an internal table-like data structure.

Input: instruction message specifying analysis scope.

Output: a raw dataset containing structured fields and text fields stored in an internal data structure.

### Step 3:

The server normalizes and cleans the structured portion of the data.

The server scans each record in the raw dataset to detect missing values, inconsistent formats, and heterogeneous category labels. The server converts date strings to standardized time objects, converts numeric strings to numerical types, and maps various status labels to unified internal codes. The server removes records that lack mandatory identifiers and imputes missing numeric values using pre-defined rules (for example, column median). The server thereby transforms heterogeneous structured data into a consistent, machine-processable form.

Input: raw dataset containing structured and unstructured fields.

Output: a cleaned structured dataset with normalized types and reduced missing values.

### Step 4:

The server preprocesses the unstructured text fields using natural language processing.

The server extracts text fields such as descriptions and feedback from the raw dataset and applies tokenization, part-of-speech tagging, and optional lemmatization or stemming using a natural language processing library. The server removes stop words and special characters, then joins the remaining tokens into cleaned text strings. The server writes these cleaned text strings into an additional column of the dataset, aligning them with corresponding records.

Input: raw unstructured text fields associated with each record.

Output: cleaned text fields suitable for feature extraction stored in the dataset.

### Step 5:

The server generates feature representations from the cleaned text and structured data.

The server applies a text vectorization procedure, such as TF-IDF, to the cleaned text column to compute a numerical vector for each record, controlling vocabulary size and n-gram range according to configuration parameters. The server also selects numeric attributes from the structured dataset, such as durations, amounts, and scores, and applies scaling (for example, standardization) so that no single attribute dominates distance calculations. The server concatenates the text-based vectors and scaled numeric attributes into a unified feature matrix, with each row representing one record and each column representing a feature component.

Input: cleaned structured dataset and cleaned text fields.

Output: a unified feature matrix and a mapping from each row to its corresponding record identifier.

### Step 6:

The server performs clustering on the feature matrix to discover groups of similar records.

The server selects a clustering algorithm and determines an appropriate number of clusters, for example by evaluating clustering quality metrics across candidate cluster counts. The server initializes cluster centroids and iteratively assigns each row of the feature matrix to the nearest centroid according to a distance measure. After each assignment step, the server recomputes centroids as mean vectors of their assigned members and repeats the process until convergence criteria are met. The server thereby partitions the records into clusters that share similar feature patterns.

Input: unified feature matrix and configuration parameters for clustering.

Output: cluster assignments for each record and cluster centroids stored in internal data structures.

### Step 7:

The server derives pattern information and trend information from the clustering results.

The server aggregates records by cluster and calculates statistics such as mean and variance of numeric attributes, distribution of categorical attributes, and average outcome indicators. The server also aggregates text-based features by computing average TF-IDF weights per term within each cluster and selecting highest-weighted terms as representative keywords and phrases. The server compares metrics between clusters to detect systematic differences, thereby identifying patterns (for example, high satisfaction with short duration) and trends (for example, increasing performance across certain time periods).

Input: cluster assignments, cluster centroids, and original feature matrix.

Output: pattern information and trend information, including representative keywords, attribute summaries, and outcome statistics for each cluster.

### Step 8:

The server generates structured analysis results including success factors and risk factors.

The server analyzes the pattern and trend information to identify attributes strongly associated with favorable or unfavorable outcomes. The server computes measures such as correlation coefficients or differences in mean outcome indicators between clusters. When an attribute exceeds a predetermined threshold of positive association with favorable outcomes, the server labels it as a potential success factor; when an attribute exhibits strong association with unfavorable outcomes, the server labels it as a potential risk factor. The server composes structured analysis results that package, for each cluster, its representative keywords, attribute summaries, outcome indicators, and derived success and risk factors.

Input: pattern information and trend information for all clusters.

Output: structured analysis results encoding clusters, patterns, trends, and labeled success and risk factors.

### Step 9:

The server constructs a prompt sentence for a generative AI model using the structured analysis results.

The server formats a natural language instruction that describes the analysis context and the task to be performed by the generative AI model. The server reads the structured analysis results and embeds summaries of clusters, representative keywords, and key metrics into the prompt text so that the model receives an informative yet concise description. The server may, for example, construct a prompt sentence such as:

“Analyze the following clustered business task data and generate a structured report.
Cluster 1: high satisfaction score, short duration, keywords: ‘frequent status meetings’, ‘transparent communication’, ‘on-time delivery’.
Cluster 2: low satisfaction score, long duration, keywords: ‘delivery delay’, ‘scope change’, ‘resource shortage’.

Explain the main success factors and risk factors, and propose at least three concrete recommendations for improving future business tasks.”

Input: structured analysis results containing cluster summaries and factor labels.

Output: a prompt sentence that encodes instructions and context for the generative AI model.

### Step 10:

The server invokes the generative AI model with the prompt sentence and generates a natural-language report.

The server submits the prompt sentence to a generative AI model via an application programming interface or an internal model invocation mechanism. The server configures parameters such as maximum output length and sampling strategy and then triggers the model to generate output tokens. The generative AI model processes the prompt through multiple internal layers and returns a sequence of tokens representing sentences. The server decodes the tokens into a text string and optionally segments the text into logical sections such as overview, findings, and recommendations.

Input: constructed prompt sentence and model configuration parameters.

Output: a natural-language report text generated in response to the prompt.

### Step 11:

The server formats the generated report and transmits it to the terminal.

The server takes the report text and applies formatting rules, such as inserting headings, bullet lists, or highlighting key factors, to create report information suitable for presentation. The server associates metadata such as generation time and analysis conditions with the report. The server then sends the report information to the terminal via the communication interface.

Input: raw report text from the generative AI model.

Output: formatted report information transmitted to the terminal.

### Step 12:

The terminal presents the report to the user and collects feedback for re-analysis.

The terminal receives the report information from the server and renders it on a display. The user reads the report and may decide to refine the analysis by changing conditions or viewpoints, such as focusing on specific time periods or emphasizing different attributes. The terminal captures these new user inputs and encodes them as updated instruction information, which can be sent to the server to initiate another analysis cycle.

Input: report information received from the server and user interactions with the display and input devices.

Output: updated instruction information for further analyses transmitted from the terminal to the server.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In industrial environments, large quantities of heterogeneous data are generated and stored, including time-series sensor measurements, operation histories of production equipment, and free-text maintenance records authored by human operators. Conventional computer systems typically treat these data streams separately: numerical sensor data are processed by domain-specific analytic tools, while unstructured text is archived with minimal or no semantic analysis. As a result, existing systems have limited capability to synthesize these heterogeneous data types into a unified representation that can support accurate failure prediction and actionable preventive maintenance planning.

In particular, conventional systems suffer from several technical limitations. First, they lack a robust mechanism for automatically transforming unstructured maintenance descriptions into machine-usable structured knowledge, such as standardized categories of components, symptoms, and treatments. This prevents the computing apparatus from effectively correlating human experience and know-how with measured operational states of equipment. Second, existing predictive maintenance solutions often train failure prediction models solely on raw numeric sensor values, without incorporating semantically enriched textual information, leading to suboptimal model performance and reduced generalizability across different equipment types and operating conditions. Third, even when prediction models are deployed, conventional systems typically present results as static risk scores or alarms, without leveraging advanced generative artificial intelligence to derive higher-level insights or to generate customized maintenance strategies that account for the full operational context.

Further, current computer-implemented maintenance support systems generally require skilled engineers to manually construct queries, analyze model outputs, and draft maintenance plans. This results in increased cognitive load, inconsistent decision quality, and limited scalability across multiple plants or lines. It also restricts non-expert users from fully utilizing the underlying data and models. Moreover, as generative artificial intelligence models become available, existing systems do not provide an integrated framework for programmatically constructing context-rich prompt sentences that embed structured analysis results, nor for systematically aligning generative outputs with concrete operational constraints such as equipment schedules and expected downtime.

Accordingly, there is a need for an improved computer system and associated processing techniques that: (i) automatically integrate time-series operational data and textual maintenance information into a unified, feature-rich representation; (ii) construct and deploy predictive models that leverage both numeric and semantically structured textual features to compute equipment failure risk; and (iii) generate, via interaction with a generative artificial intelligence model using dynamically constructed prompt sentences, context-aware and operationally feasible preventive maintenance recommendations. Such a system should reduce manual analytic effort, improve prediction accuracy, enhance the usability of complex analytic results for diverse users, and thereby constitute a concrete improvement in the functioning of computer-based maintenance support systems.

The specific processing by the specific processing unit 290 of the data processing device 12 in Application Example 1 is realized by the following means.

The present invention provides a server comprising a processor and a memory storing instructions which, when executed by the processor, cause the processor to acquire, from at least one external apparatus and at least one recording medium, information related to operations executed within an organizational entity, store the acquired information as integrated data including measurement values and historical information indicating operation states of production equipment and text information describing contents of maintenance work, perform string analysis on the text information and execute natural language processing including morphological analysis and part-of-speech classification to extract terms indicating a maintenance target element, a sign of abnormality, and a countermeasure, convert the extracted terms into structured knowledge as standardized labels including a component category, a symptom category, and a treatment category, generate time-series features and categorical features based on the measurement values and the structured knowledge, create training data in which the features are associated with presence or absence of future failure occurrence, construct, by using a statistical learning algorithm or a neural network, a prediction model configured to output a failure occurrence probability of the production equipment during a predetermined future period using the training data as input, store the prediction model in the memory, input to the prediction model features based on latest measurement values acquired from the production equipment in operation and the structured knowledge, generate an analysis result including a failure risk index and a preventive maintenance candidate for each production equipment, embed analysis data summarizing the analysis result as additional information into a prompt sentence to be used as input text to a generative artificial intelligence model, generate the prompt sentence that instructs the generative artificial intelligence model to generate findings having unexpectedness regarding a preventive maintenance plan or a measure for improving operation efficiency, acquire a response output from the generative artificial intelligence model, and output the response in association with the failure risk index and the preventive maintenance candidate to at least one display device or notification device. This enables the server to technically improve computer functionality by automatically transforming heterogeneous operational and textual data into a unified, model-ready representation, executing integrated predictive analytics to compute equipment failure risk, and programmatically constructing context-rich prompt sentences that drive a generative artificial intelligence model to produce operationally constrained, user-adaptive maintenance recommendations, thereby reducing computational inefficiencies, lowering user workload, and enhancing the reliability and usability of computer-implemented maintenance support.

The term “organizational entity” refers to an organization such as a company, factory, or business unit within which operations, production activities, and maintenance tasks are executed.

The term “external apparatus” refers to any external hardware device or system that supplies data to the server, including control devices, sensing devices, and management systems.

The term “recording medium” refers to any physical or logical storage medium capable of storing digital information, including magnetic storage, optical storage, and semiconductor memory, as well as logical storage volumes provided by such media.

The term “production equipment” refers to machinery, devices, or installations used to perform manufacturing or processing operations in an industrial environment.

The term “operation state” refers to a condition or status of production equipment during use, including operating mode, load level, temperature, vibration level, and other measurable parameters.

The term “measurement value” refers to a numeric value obtained from a sensing device or monitoring system that quantitatively represents a physical or operational property of production equipment.

The term “historical information” refers to data representing past events or states of production equipment, including past measurement values, operation logs, maintenance records, and failure occurrences.

The term “maintenance work” refers to actions performed to inspect, adjust, repair, replace, or otherwise service production equipment in order to maintain or restore its functionality.

The term “integrated data” refers to a data structure in which heterogeneous data types, including measurement values, historical information, and text information, are combined and stored in a unified format with common identifiers or time references.

The term “text information” refers to data expressed in a natural language character string, including descriptions of maintenance work, failure reports, operator comments, and related narrative content.

The term “string analysis” refers to processing applied to character strings, including operations such as tokenization, normalization, and syntactic or semantic analysis.

The term “natural language processing” refers to computational techniques for processing text or speech in human languages, including morphological analysis, part-of-speech tagging, syntactic parsing, and semantic extraction.

The term “morphological analysis” refers to processing that segments a text into morphemes or word units and identifies their base forms or inflected forms.

The term “part-of-speech classification” refers to processing that assigns syntactic categories such as nouns, verbs, adjectives, or adverbs to words or tokens in a text.

The term “maintenance target element” refers to a component, subassembly, or functional part of production equipment that is the subject of maintenance work or diagnosis.

The term “sign of abnormality” refers to a symptom or indication suggesting a deviation from normal operation of production equipment, such as increased vibration, overheating, noise, or leakage.

The term “countermeasure” refers to a maintenance action or operational adjustment performed or proposed in response to a sign of abnormality, including inspection, repair, replacement, cleaning, or parameter change.

The term “structured knowledge” refers to information that has been converted from unstructured form into a predefined format with explicit fields or labels, enabling programmatic processing and analysis.

The term “standardized label” refers to a normalized representation of a concept, such as a component category, symptom category, or treatment category, defined according to a predetermined taxonomy.

The term “component category” refers to a classification label that represents a type of physical part or subsystem of production equipment, such as a drive unit, bearing, pump, or control unit.

The term “symptom category” refers to a classification label that represents a type of abnormal condition or behavior of production equipment, such as overheating, abnormal vibration, noise, or performance degradation.

The term “treatment category” refers to a classification label that represents a type of maintenance action or response to an abnormal condition, such as replacement, lubrication, adjustment, or inspection.

The term “time-series feature” refers to a derived data element representing a characteristic of measurement values over time, including statistics, trends, or lagged values of sensor signals.

The term “categorical feature” refers to a derived data element representing membership in a discrete category, such as a component label, symptom label, operating mode, or encoded text attribute.

The term “training data” refers to a collection of input features and associated target outputs used to train a prediction model by adjusting parameters of a learning algorithm.

The term “future failure occurrence” refers to an event in which production equipment enters a failure state within a predetermined time period after a given reference time.

The term “statistical learning algorithm” refers to a computational method that infers a predictive function from data using statistical principles, including, for example, regression models, decision tree models, or ensemble models.

The term “neural network” refers to a machine learning model that consists of interconnected computational units organized in layers and that is trained by adjusting connection weights to approximate a desired mapping from inputs to outputs.

The term “prediction model” refers to a trained computational model that receives input features and produces an estimate of a quantity of interest, such as a failure occurrence probability.

The term “failure occurrence probability” refers to a numeric value representing a likelihood that production equipment will experience a failure within a specified future time interval.

The term “storage area” refers to a logical region of memory or storage in which executable instructions, data structures, and trained models are stored for use by the processor.

The term “latest measurement value” refers to a measurement value that has been most recently acquired from production equipment at or near the time of executing a prediction.

The term “analysis result” refers to data output by processing performed by the prediction model or subsequent post-processing, including computed risk indicators and suggested preventive actions.

The term “failure risk index” refers to a quantitative indicator derived from the prediction model output that represents a relative or absolute level of risk that production equipment will fail within a given time horizon.

The term “preventive maintenance candidate” refers to a proposed maintenance action or set of actions that is intended to reduce the likelihood of future equipment failure or mitigate its impact.

The term “analysis data” refers to data derived from the analysis result, including summaries, statistics, and context information that are suitable for use as input to a generative artificial intelligence model.

The term “prompt sentence” refers to a text sequence provided as input to a generative artificial intelligence model to instruct the model on a desired task, context, or output format.

The term “generative artificial intelligence model” refers to a trained computational model configured to generate natural language or other content in response to an input prompt, based on learned patterns from training data.

The term “finding having unexpectedness” refers to an insight, recommendation, or correlation produced by processing that is not readily apparent from raw data or simple rules and that provides additional value to a user.

The term “measure for improving operation efficiency” refers to a recommended change in operation, scheduling, configuration, or maintenance that is intended to increase throughput, reduce downtime, or otherwise improve performance of production equipment.

The term “display device” refers to any device capable of visually presenting information to a user, including a monitor, terminal screen, mobile display, or graphical user interface.

The term “notification device” refers to any device or mechanism configured to deliver alerts or messages to a user, including, for example, an electronic mail system, a mobile notification system, or an audible or visual alarm.

The term “query sentence” refers to a natural language text string entered by a user to request information, analysis, or recommendations from the system or from a generative artificial intelligence model.

The term “input/output device” refers to any device through which a user can input data to the server and receive data from the server, including a keyboard, pointing device, touchscreen, or terminal interface.

The term “extraction range” refers to a selection scope within stored analysis data from which information is retrieved for inclusion in a prompt sentence or for presentation to a user.

The term “summary content” refers to a reduced or condensed representation of detailed analysis data, highlighting essential patterns, statistics, or conclusions.

The term “operation schedule data” refers to data representing planned or actual operation schedules of production equipment, including planned running times, planned stoppages, and maintenance windows.

The term “recommended maintenance action” refers to a specific maintenance procedure or set of procedures suggested by the system or by a generative artificial intelligence model to address or prevent equipment issues.

The term “operation change plan” refers to a proposed modification of how production equipment is operated, scheduled, or configured in order to achieve improved reliability or efficiency.

The term “evaluation information” refers to data indicating characteristics of a recommended maintenance action or operation change plan, such as feasibility, required resources, expected downtime, or anticipated benefit.

The term “feasibility” refers to a degree to which a recommended maintenance action or operation change plan can be implemented given existing constraints such as time, resources, and equipment availability.

The term “expected downtime” refers to an estimated duration of time during which production equipment will be unavailable for normal operation due to implementing a maintenance action or operation change plan.

The term “reconfigured information” refers to information produced by modifying, augmenting, or rearranging a response output, including the addition of evaluation information and contextual data prior to presentation to a user.

In one embodiment, a server implements the claimed system as a network-connected data processing apparatus installed in a production facility environment. The server includes at least one central processing unit, a main memory, a non-volatile storage device, a network interface, and an operating system such as a general-purpose server operating system. The server executes an application program written in a high-level language such as a scripting language, and uses software libraries including a data analysis library, a natural language processing library, a machine learning library, and a neural network framework. Examples of such libraries include a tabular data processing library that provides data frame structures, a natural language toolkit, a natural language pipeline library, a statistical learning toolkit, and a neural network toolkit. The server communicates with external apparatuses such as industrial controllers, sensor gateways, and management systems via wired or wireless networks using protocols such as a fieldbus protocol, a message queue protocol, or a hypertext transfer protocol.

In this embodiment, the server acquires measurement values and historical information from production equipment installed in a factory. The server receives time-series sensor data such as temperature, vibration, electric current, and rotational speed from sensor devices attached to each piece of production equipment. The server also acquires operation logs and maintenance histories from a manufacturing execution system or a maintenance management system. Furthermore, the server obtains text information in the form of maintenance reports, failure descriptions, and operator comments stored in a database or as files. The server converts these heterogeneous data into integrated data by aligning time stamps and equipment identifiers and by storing the combined records in a data frame or relational table that includes fields for measurement values, operation state indicators, and associated text strings.

The server performs specific data processing on the text information to convert human-authored descriptions into structured knowledge. The server uses a natural language processing pipeline that includes tokenization, sentence segmentation, morphological analysis, and part-of-speech classification. For example, the server applies a pre-trained language model from the natural language pipeline library to each maintenance report, thereby generating, for each token, attributes such as lemma, part-of-speech tag, and dependency relation. The server then applies pattern matching rules using a matcher component to detect expressions corresponding to maintenance target elements, signs of abnormality, and countermeasures. Example rules include patterns such as a verb indicating a repair action followed by a noun phrase indicating a machine part, or an adjective indicating an abnormal condition followed by a noun representing a measured physical quantity.

The server maps the extracted terms to standardized labels defined in a domain ontology. The server maintains a mapping table that associates surface forms and synonyms (for example, “bearing,” “roller,” “shaft bearing”) with a component category label, and similarly maps terms such as “vibration,” “noise,” “shaking” to a symptom category label, and terms such as “replace,” “change out,” “swap” to a treatment category label. The server stores the resulting component category, symptom category, and treatment category as structured fields in the integrated data. By converting free-text content into such standardized labels, the server creates a consistent feature representation that can be processed efficiently by subsequent machine learning algorithms, and reduces ambiguity and inconsistency that would arise from direct use of raw text.

The server generates time-series features from the measurement values for each piece of production equipment. The server groups sensor data by equipment identifier and resamples the data into fixed time intervals, for example, 5-minute or 1-hour windows. For each interval, the server computes statistical values such as mean, maximum, minimum, variance, and higher-order moments of temperature, vibration, and other signals. The server also computes trend-based features such as linear regression slopes, moving averages, and exponentially weighted moving statistics. In addition, the server constructs lag features by including measurement values from previous intervals to capture temporal dependencies. These operations are executed using vectorized data frame operations, which improves processing speed and reduces memory overhead compared to naive iteration.

The server combines the time-series features with the categorical features derived from structured knowledge. The server transforms component category, symptom category, and treatment category into numerical representations by one-hot encoding or embedding vectors. For example, the server uses a one-hot encoder from the statistical learning toolkit to generate binary indicator vectors for each category, or uses a pre-trained word embedding model to obtain dense vectors for component and symptom labels and aggregates them into feature vectors. The server then concatenates the numerical sensor features and the categorical features for each time interval and each piece of equipment, forming a high-dimensional feature vector that represents both physical measurements and human-derived experience.

The server constructs training data by associating each feature vector with a label indicating whether a failure occurs within a predetermined future period, such as the next 24, 48, or 72 hours. To assign labels, the server scans historical failure records for each equipment identifier and marks intervals preceding a recorded failure within the target horizon as positive examples, and intervals far from any failure event as negative examples. The server may optionally apply techniques such as undersampling of majority class intervals or weighting of minority class labels to address class imbalance, thereby improving the stability and accuracy of the prediction model.

The server trains a prediction model using the constructed training data. In one embodiment, the server uses a statistical learning algorithm such as a random forest classifier or a gradient boosting classifier. The server initializes a model with a plurality of decision trees, each receiving subsets of features and training samples, and optimizes hyperparameters such as number of trees, maximum tree depth, and learning rate by cross-validation. The server computes an error function such as cross-entropy loss or misclassification rate on a validation set and selects hyperparameters that minimize the error.

In another embodiment, the server uses a neural network model implemented with the neural network toolkit. The server constructs a feed-forward neural network including an input layer matching the dimension of the combined feature vector, one or more hidden layers with non-linear activation functions such as rectified linear units, and an output layer with a sigmoid activation that outputs a failure occurrence probability between zero and one. The server initializes model weights using a standard initialization method, and performs supervised learning using stochastic gradient descent or an adaptive optimizer such as Adam. The server defines a loss function, for example, binary cross-entropy between predicted probabilities and true labels, and updates weights by backpropagation using mini-batches of feature vectors. The server monitors metrics such as validation loss, area under the receiver operating characteristic curve, and F1 score, and applies early stopping when improvement stabilizes, thereby controlling overfitting and improving generalization.

In a further embodiment, the server uses a recurrent neural network or a temporal convolutional network to directly model time-series dependencies. The server arranges sequences of time-ordered feature vectors for each equipment into input sequences and feeds them into layers such as long short-term memory units or gated recurrent units. This architecture allows the server to capture long-range temporal patterns that may precede equipment failures, improving early detection accuracy. The server again uses a cross-entropy loss function and an adaptive optimizer, and tunes parameters such as number of layers, number of units per layer, sequence length, and dropout rate.

By explicitly defining feature engineering and model architectures, the server improves processing efficiency compared to purely manual analysis. Vectorized operations on data frames, structured categorical encodings, and batch-oriented training allow the server to process large-scale sensor and text datasets faster than traditional relational query-based workflows. At the same time, the use of combined sensor and structured text features increases the discriminative power of the prediction model, improving the precision and recall of failure predictions. This technical combination reduces false alarms and missed detections and directly improves utilization of production equipment.

After the prediction model has been trained, the server stores the trained model parameters and associated pre-processing configuration in the storage device. During operation, the server periodically acquires latest measurement values from production equipment and updates the integrated data structure. The server applies the same feature generation pipeline used for training to the latest data, ensuring consistent scaling and encoding. The server then inputs the resulting feature vectors into the stored prediction model and obtains, for each equipment, a failure occurrence probability and optionally additional outputs such as classification logits or intermediate activations.

The server calculates a failure risk index from the prediction model output. In a basic configuration, the risk index is equal to the predicted probability. In more advanced configurations, the server combines the probability with other factors such as equipment criticality, repair lead time, and maintenance cost using a weighted formula. The server stores the risk index, together with the standardized component and symptom categories, in an analysis result structure associated with timestamps and equipment identifiers. The server further records preventive maintenance candidates by applying rule-based mappings from predicted failure modes to maintenance actions; for example, a pattern of abnormal vibration associated with a bearing component category results in a preventive maintenance candidate such as “inspect and replace bearing.”

The server uses these analysis results as context for interaction with a generative AI model. The server constructs analysis data summaries that capture key numerical and categorical information in a compact form. For example, the server may compute, for each line of equipment, the count of high-risk machines, the distribution of predicted failure horizons, and the most frequent symptom categories in the past week. The server formats this analysis data as text sentences or bullet points describing the context of the factory's current condition in a human-readable yet structured way.

The server generates a prompt sentence by combining the analysis data with instructions for the generative AI model and, optionally, a query sentence provided by a user via a terminal. For example, when a user inputs at the terminal:

“Analyze all bearing-related failures in the last 6 months and propose a preventive maintenance plan to reduce downtime.” the server acquires the query sentence and extracts references to “bearing-related failures” and “last 6 months.” The server queries its analysis database to compute statistics such as total count of bearing-related failures, average time between such failures, and average downtime per event. The server then constructs a prompt sentence such as: “You are a maintenance optimization assistant. Data summary: In the last 6 months, there were 42 bearing-related failures across all lines. The most common symptoms were abnormal vibration (68%) and overheating (45%). The average time between bearing failures on Machine A is 23 days, and the average downtime per failure is 6.3 hours. Based on this data, analyze the bearing-related failures and propose a preventive maintenance plan to reduce downtime.”

The server sends this prompt sentence as input text to the generative AI model via an application programming interface. The generative AI model may be a large language model running on the same server or on a remote server equipped with a graphics processing unit or specialized accelerator. The server sets model parameters such as temperature, maximum output length, and response format to control the behavior of the generative AI model. The generative AI model generates a response that describes suggested inspection intervals, recommended spare part stocking levels, and operational adjustments. The server acquires the response, attaches metadata such as the equipment to which the recommendations apply, and stores the response in association with the corresponding risk indices and preventive maintenance candidates.

The terminal functions as a user interface device that displays the analysis results and generative AI responses to users. The terminal may be a desktop computer, a tablet device, or a handheld terminal, running a web browser or a dedicated client application. The terminal sends user authentication information to the server and requests views of current risk indices, recommended maintenance actions, and AI-generated plans. The terminal displays, for example, a list of machines sorted by failure risk index, each accompanied by the corresponding predicted failure horizon, detected component and symptom categories, and textual recommendations. The terminal also presents input fields allowing the user to enter query sentences in natural language, which are transmitted to the server for inclusion in prompt sentences.

The user interacts with the terminal to understand and act upon the server's outputs. The user can, for instance, inspect why a specific machine is flagged as high risk. In response to a query such as:

“Explain in simple terms why Machine C is predicted to fail within the next 72 hours, and what I should do today.”

the server retrieves the recent feature values and prediction model outputs for Machine C, summarizes factors that contributed most to the prediction (for example, rising vibration slope, recent symptom category of overheating), and embeds these as context into the prompt sentence to the generative AI model. The resulting explanation may indicate that repeated abnormal vibration events combined with recent overheating comments and a historically short interval between similar failures strongly increase the risk, and may suggest an immediate inspection and preparation of relevant spare parts.

From a technical perspective, this architecture provides more than mere automation of a human mental process. The server introduces a specific data flow and model pipeline that are optimized for heterogeneous industrial data. By converting unstructured text into standardized categories and combining them with time-series statistics, the server enables the prediction model to leverage patterns that would be difficult or impractical for a human engineer to quantitatively integrate across millions of records. The use of vectorized data frame operations, compressed storage formats, and batch model inference reduces computational overhead and improves throughput, enabling near real-time monitoring of entire production lines.

In addition, by programmatically constructing prompt sentences that include precise analytic summaries and risk indices, the server controls the generative AI model in a deterministic and repeatable manner. This differs from manual use of generative models where human operators craft ad hoc prompts. The server's prompt construction algorithm enforces consistent inclusion of key features such as failure counts, symptom distributions, and predicted horizons, thereby improving the reliability and relevance of generated recommendations. This structured prompting constitutes a specific improvement to how generative AI models are integrated into computer-based maintenance systems, as it reduces variability, improves response quality, and facilitates automated downstream processing of AI outputs.

Alternative embodiments may vary in hardware configurations and algorithms. For example, the server may use a relational database or a columnar store for integrated data, and may use a different natural language processing framework for tokenization and parsing. The prediction model may be implemented as a gradient boosting machine, a convolutional neural network applied to transformed time-series, or a hybrid model combining rule-based logic with learned probabilities. The server may deploy the generative AI model locally or access it as a remote service. The terminal may be a mobile terminal used on the factory floor, while users interact with speech input and receive audio explanations.

In all these embodiments, the essential technical features include: (i) structured transformation of heterogeneous operational and textual data into an integrated representation optimized for machine learning; (ii) construction and deployment of models that output quantitative failure risk indices from such integrated features; and (iii) algorithmic generation of context-rich prompt sentences that guide a generative AI model to produce maintenance recommendations tightly coupled to computed risk and operational constraints. This causally results in improved prediction accuracy, faster analysis, consistent and data-grounded recommendations, and reduced network and computation overhead through compact summarization of large datasets before transmission to the generative AI model.

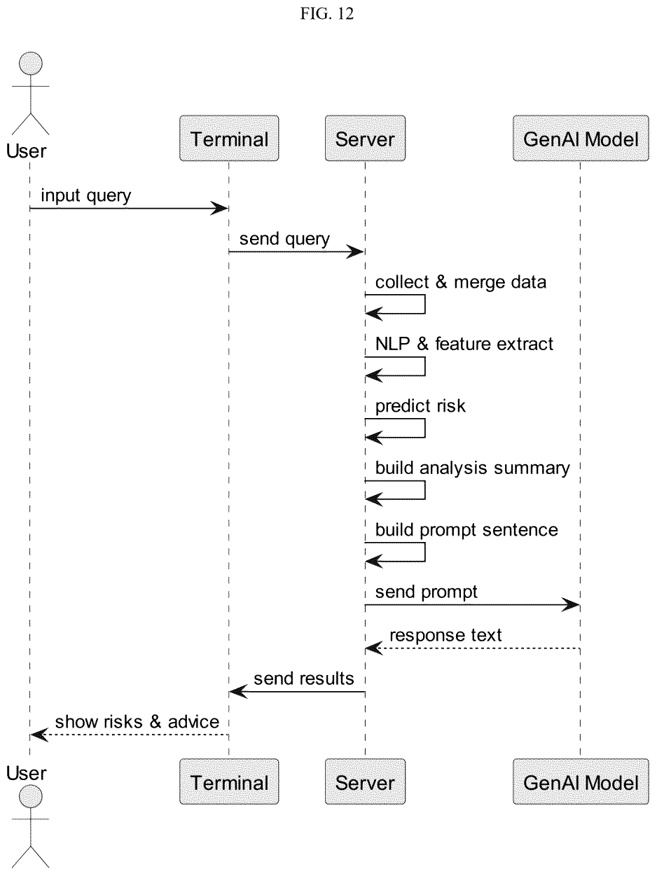

The following describes the processing flow using FIG. 12.

### Step 1:

The server acquires raw data from external apparatuses and recording media. The server receives, as input, time-series measurement values and operation logs from controllers and sensor gateways, and text information such as maintenance reports and failure descriptions from databases or files. The server parses communication messages, converts timestamps to a unified time zone, associates equipment identifiers with each record, and writes the normalized records into an integrated storage structure such as a relational table or data frame. The output of Step 1 is a set of synchronized raw datasets that include numeric sensor streams, historical event logs, and corresponding text fields, each tagged with equipment IDs and timestamps.

### Step 2:

The server constructs integrated data by joining heterogeneous datasets. The server takes, as input, the normalized sensor datasets, operation history datasets, and text datasets produced in Step 1. The server performs join operations based on equipment identifiers and time windows, aligns sensor records with corresponding maintenance events, and aggregates measurements over fixed intervals using statistical aggregation functions. The server creates, for each equipment and time interval, a composite record containing measurement values (such as mean and maximum sensor readings), status flags, and one or more associated text strings. The output of Step 2 is an integrated dataset in which each row represents a time-interval event for a specific equipment, including both numeric and textual fields prepared for further analysis.

### Step 3:

The server executes natural language preprocessing on the text information. The server receives, as input, the text fields from the integrated dataset, including maintenance comments, failure descriptions, and operator notes. The server performs tokenization, sentence segmentation, morphological analysis, and part-of-speech tagging using a natural language processing library. The server applies normalization operations such as lowercasing, removal of extraneous symbols, and expansion of abbreviations. Based on the tagged tokens, the server identifies candidate phrases representing components, symptoms, and treatments. The output of Step 3 is a token-level and phrase-level representation of the text, in which each original text entry is linked to a structured list of extracted terms and their linguistic attributes.

### Step 4:

The server converts extracted terms into structured knowledge with standardized labels. The server uses, as input, the token and phrase information generated in Step 3 together with a predefined mapping table or ontology. The server compares extracted component phrases against the mapping table, assigns a component category label, and similarly maps symptom phrases and treatment phrases to symptom category and treatment category labels. In cases of ambiguity, the server applies disambiguation rules such as prioritizing exact matches over partial matches and using co-occurring terms to refine category selection. The server then stores, for each integrated event record, standardized labels indicating which component category, symptom category, and treatment category are present. The output of Step 4 is an augmented integrated dataset containing structured knowledge columns derived from unstructured text.

### Step 5:

The server generates time-series features from measurement values. The server receives, as input, the numeric sensor data fields within the integrated dataset. The server groups the data by equipment identifier and resamples the time dimension into fixed-size intervals. For each interval, the server calculates statistics such as mean, maximum, minimum, standard deviation, and trend indicators such as linear slope and moving average. The server also computes lagged features by referencing measurement values from preceding intervals to encode temporal evolution. The data processing consists of applying vectorized aggregation functions and sliding window operations over the time-indexed data. The output of Step 5 is a feature matrix of time-series statistics indexed by equipment and time interval.

### Step 6:

The server encodes structured knowledge into categorical features. The server uses, as input, the component category, symptom category, and treatment category labels produced in Step 4. The server applies an encoding procedure such as one-hot encoding or ordinal encoding to convert each categorical label into numerical feature vectors. When multiple labels appear in the same interval, the server aggregates them using operations such as summation or logical OR across indicator dimensions. The output of Step 6 is a set of categorical feature vectors for each equipment and time interval, compatible with numerical machine learning algorithms.

### Step 7:

The server constructs training data by associating features with future failure labels. The server receives, as input, the time-series feature matrix from Step 5, the categorical feature vectors from Step 6, and failure event records indicating actual failure times for each equipment. The server determines, for each time interval, whether a failure occurs within a predetermined future horizon (for example, 72 hours) by comparing interval timestamps with failure timestamps. The server assigns a positive label when a failure falls within the horizon and a negative label otherwise. The server concatenates the numeric and categorical features into a unified feature vector for each interval, and associates each feature vector with the corresponding label. The output of Step 7 is a labeled training dataset containing pairs of feature vectors and binary failure labels.

### Step 8:

The server trains a prediction model using the training dataset. The server uses, as input, the feature vectors and labels produced in Step 7. The server splits the dataset into training and validation subsets, applies normalization or scaling to numeric features, and trains a model such as a gradient-boosted ensemble or a neural network. For a neural network, the server defines an input layer matching the feature dimension, one or more hidden layers with non-linear activation functions, and an output layer with a sigmoid function. The server computes a loss function such as binary cross-entropy and updates model weights via backpropagation using an optimizer such as Adam. The server monitors validation metrics and applies early stopping when convergence is reached. The output of Step 8 is a trained prediction model object, stored with its learned parameters and pre-processing configuration.

### Step 9:

The server deploys the prediction model and computes failure risk indices for live data. The server takes, as input, the latest integrated data for equipment in operation, including recent sensor measurements and structured labels. The server applies the same feature generation procedures as in Steps 5 and 6, using the stored pre-processing configuration, to produce real-time feature vectors. The server feeds these feature vectors into the trained prediction model obtained in Step 8, receiving as output predicted failure probabilities for each equipment and time interval. The server optionally transforms these probabilities into failure risk indices by applying scaling or weighting rules. The output of Step 9 is a set of current failure risk indices and associated predicted failure horizons for all monitored equipment.

### Step 10:

The server derives preventive maintenance candidates from the analysis results. The server receives, as input, the failure risk indices from Step 9 and the standardized component and symptom categories from Step 4. The server evaluates each equipment's risk index against configurable thresholds to classify equipment into risk levels such as low, medium, and high. For equipment exceeding a threshold, the server uses rule-based mappings or lookup tables to determine recommended actions; for example, a combination of a high risk index and a bearing-related symptom category leads to a preventive maintenance candidate such as “inspect and replace bearing within 24 hours.” The server compiles, for each equipment, a list of preventive maintenance candidates, including recommended action types and suggested time windows. The output of Step 10 is an analysis result structure containing failure risk indices and corresponding preventive maintenance candidates.

### Step 11:

The server generates analysis summaries to be used as context for a generative AI model. The server takes, as input, the analysis result structure from Step 10. The server aggregates results by production line, component category, or time period to compute summary statistics such as total number of high-risk equipment, distribution of predicted failure horizons, and most frequent symptom categories. The server formats these statistics into textual analysis data, for example, “In the last 7 days, 12 machines have been classified as high risk, with 8 cases related to bearing components and 4 cases related to drive units.” The server ensures that the analysis data is concise yet informative by selecting key metrics according to predefined rules. The output of Step 11 is a set of analysis data strings that summarize the current and recent conditions of the production environment.

### Step 12:

The terminal acquires user query sentences for refinement of prompt sentences. The terminal receives, as input, natural language text entered by the user via a keyboard, touchscreen, or other input device. The terminal displays an input field labeled, for example, “Ask the maintenance assistant,” and transmits the entered query sentence to the server over a network connection. Example query sentences include “Analyze all bearing-related failures in the last 6 months and propose a preventive maintenance plan to reduce downtime.” and “Explain in simple terms why Machine C is predicted to fail within the next 72 hours, and what I should do today.” The output of Step 12 is a message containing the user's query sentence and associated user context information, forwarded to the server.

### Step 13:

The server constructs a prompt sentence for the generative AI model by combining analysis data and user query. The server uses, as input, the analysis data strings produced in Step 11 and the query sentence provided by the terminal in Step 12. The server parses the query sentence to detect references to time spans, equipment identifiers, and component types, and uses these references to select a relevant subset of analysis data. The server then concatenates an instruction part, such as “You are a maintenance optimization assistant,” with selected analysis data and the user's query sentence into a single prompt sentence. The server ensures that the prompt sentence clearly specifies the task, context, and expected output format for the generative AI model. The output of Step 13 is a context-rich prompt sentence ready to be transmitted to the generative AI model.

### Step 14:

The server sends the prompt sentence to the generative AI model and receives a response. The server takes, as input, the prompt sentence from Step 13. The server formats the prompt as a request to a generative AI model endpoint and includes control parameters such as temperature and maximum token length. The server transmits the request over a network to a local or remote generative AI model execution environment. The generative AI model generates, in response to the prompt sentence, a textual output that may include explanations, maintenance plans, and prioritized actions. The server receives the generated text as the model's response. The output of Step 14 is the raw response text produced by the generative AI model corresponding to the context and query contained in the prompt sentence.

### Step 15:

The server post-processes the generative AI response and associates it with analysis results. The server uses, as input, the raw response text from Step 14 and the analysis result structure from Step 10. The server parses the response to identify references to specific equipment, time frames, or action types, and links them to existing failure risk indices and preventive maintenance candidates. The server may segment the response into actionable items and annotations and add metadata such as recommended implementation time and required resources. The server constructs a composite output object that pairs the explanation and recommendations from the generative AI model with the underlying quantitative analysis data. The output of Step 15 is a structured representation of recommendations and explanations aligned with computed risk metrics.

### Step 16:

The terminal displays the analysis results and generative AI recommendations to the user. The terminal receives, as input, the composite output object produced by the server in Step 15. The terminal renders a visual interface that lists equipment with their failure risk indices, preventive maintenance candidates, and corresponding generative AI explanations. The terminal may highlight high-risk equipment and emphasize urgent recommendations. The terminal also allows the user to scroll, filter, and drill down into details for a particular machine or component. The output of Step 16 is a human-readable display on the terminal screen that enables the user to understand and act upon the system's predictions and generated recommendations.

### Step 17:

The user examines the displayed information and initiates follow-up interactions. The user receives, as input, the visual information provided by the terminal in Step 16. Based on the displayed risk indices and recommendations, the user may decide to schedule maintenance actions, adjust operational parameters, or request additional clarification. When further clarification is desired, the user enters new query sentences into the terminal, such as “Refine the plan for Machine A to minimize downtime during the night shift.” The user's follow-up inputs are then forwarded by the terminal to the server, thereby closing the interaction loop and enabling iterative refinement of prompt sentences and generated plans. The output of Step 17 is updated user input that can trigger additional executions of Steps 12 through 16.

It is also possible to incorporate an emotion engine for estimating the user's emotions. That is, the specific processing unit 290 may estimate the user's emotions using an emotion identification model 59, and perform specific processing based on the estimated emotions.

### EXAMPLE 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented business analysis systems are mainly designed to aggregate numerical data and output static reports or dashboards. Such systems typically perform fixed analytics pipelines, such as summarizing sales by period or segment, and then present the results as charts or tables. These systems do not efficiently transform heterogeneous business information, including documents, records, and structured transaction logs, into higher-level knowledge units that can be reused in downstream automated reasoning. As a result, a large amount of computationally processed data still requires substantial human interpretation, and the computer largely serves only as a calculation and display tool.

Furthermore, even when machine learning techniques are applied, existing systems often treat model outputs—such as predictions, clusters, or rules—as end products. They do not provide a computer-implemented mechanism for converting such outputs into structured knowledge representations and then automatically formulating input instructions, in the form of prompt sentences, that effectively drive a generative AI model to produce context-appropriate, actionable business ideas. Prompt engineering is typically performed manually by human users, which introduces inconsistency, depends on individual expertise, and prevents the system from fully exploiting machine-oriented pattern extraction capabilities.

In addition, conventional systems have limited ability to adapt their analysis and prompt generation logic based on user feedback. Even when users indicate which generated ideas are useful or not useful, such feedback is rarely integrated into the core analysis pipeline or prompt construction process in a systematic, machine-executable manner. This results in static, non-learning workflows where the interaction loop between user evaluation and system behavior is weak or absent, thereby reducing the effectiveness of the system over time.

There is also a technical challenge in coordinating multiple heterogeneous components—such as data preprocessing modules, machine learning engines, knowledge representation stores, and generative AI models—in a unified architecture that allows the computer system itself to (i) automatically derive knowledge units from raw business data, (ii) automatically construct prompt sentences embedding such knowledge units and constraint conditions, and (iii) automatically generate and present idea information in a format tailored to the user's specified analysis purpose. Without such integrated coordination, the burden of orchestration is shifted to the human user, limiting scalability and creating fragmentation between data processing and idea generation.

Accordingly, there is a need for an improved computer system and method that (1) systematically transforms business-related information into machine-usable knowledge information, (2) automatically generates structured prompt sentences for a generative AI model based on the knowledge information and user-specified analysis purposes, (3) uses the generative AI model to produce idea information such as business improvement plans or product/service proposals, and (4) adaptively refines its data analysis and prompt generation logic based on user feedback. By addressing these problems, the invention aims to improve the functioning of the computer itself as an information processing apparatus, enabling the computer to execute more advanced, automated reasoning workflows with reduced dependence on manual configuration and ad hoc prompt design.

The specific processing by the specific processing unit 290 of the data processing device 12 in Example 2 is realized by the following means.

The present invention provides a server comprising a processor and a storage device, the processor being configured to collect business-related document information, record information, and structured data information, and store the collected information in the storage device; perform data analysis processing including data preprocessing, feature extraction, and machine learning on the business-related information stored in the storage device, and extract knowledge information including pattern information and trend information from the business-related information; store the extracted knowledge information as internal representation information structured in units of knowledge; convert the internal representation information into human-readable description information, generate prompt sentence information including the description information and generation-instruction information, and generate a prompt sentence that instructs input of the prompt sentence information into a generative information processing model; cause the generative information processing model to perform text generation processing to generate idea information including business improvement plan information, measure plan information, product proposal information, or service proposal information based on the prompt sentence information and the knowledge information; present the idea information to a user via a display device; acquire operation information, evaluation information, or additional prompt sentence information from the user, record a correspondence relationship between the evaluation information and the prompt sentence information and the idea information, and update at least one of processing conditions of the data analysis processing and processing conditions of generation of the prompt sentence information based on the correspondence relationship; and generate prompt sentence information to which constraint condition information including target business domain information, target period information, target group information, and output format information is automatically added, based on content of the knowledge information and analysis-purpose information designated by the user, and cause the generative information processing model to generate idea information specialized for a corresponding business domain by inputting the prompt sentence information including the constraint condition information to the generative information processing model. This enables an improved computer-implemented workflow in which the server automatically transforms heterogeneous business data into structured knowledge, automatically constructs and adapts prompt sentences for a generative AI model, and iteratively refines both analytical and generative behaviors based on user feedback, thereby enhancing the technical performance and autonomy of the information processing system.

The term “business-related document information” refers to text-based information describing business activities, including, but not limited to, reports, contracts, meeting minutes, specifications, manuals, and other electronic documents stored in formats such as text files, word-processing files, or portable document files.

The term “record information” refers to log-type or transactional information representing individual business events or operations, including, but not limited to, transaction logs, access logs, operational histories, and event records stored in a time-series or event-based format.

The term “structured data information” refers to information represented in a predefined schema or tabular format, including, but not limited to, records stored in relational databases, spreadsheets, comma-separated value files, and other data structures with explicit fields and data types.

The term “storage device” refers to a hardware or virtual component configured to store digital data, including, but not limited to, non-volatile storage, volatile storage, and network-attached storage.

The term “data analysis processing” refers to a series of computer-executed operations that transform input data into derived information, including, but not limited to, data preprocessing, feature extraction, machine learning, and statistical analysis.

The term “data preprocessing” refers to processing that prepares raw data for analysis, including, but not limited to, data cleaning, normalization, missing-value handling, type conversion, and format standardization.

The term “feature extraction” refers to processing that derives explanatory variables or attributes from raw data for use in analytical models, including, but not limited to, aggregation, transformation, encoding, and dimensionality reduction.

The term “machine learning” refers to processing in which a computer constructs or applies a model that maps input data to output values based on learned parameters, including, but not limited to, supervised learning, unsupervised learning, and reinforcement learning.

The term “knowledge information” refers to higher-level information derived from data analysis processing that expresses relationships, patterns, or regularities among data, including, but not limited to, pattern information and trend information.

The term “pattern information” refers to information representing recurring combinations, correlations, or structures discovered in data, including, but not limited to, association rules, clusters, and classification patterns.

The term “trend information” refers to information representing changes or tendencies of values over time, segments, or other dimensions, including, but not limited to, increasing trends, decreasing trends, seasonal variations, and cyclical behaviors.

The term “internal representation information” refers to a machine-usable data structure that encodes knowledge information in a structured manner, including, but not limited to, key-value data, graph structures, and hierarchical records.

The term “units of knowledge” refers to minimal or atomic segments of knowledge information that can be individually stored, referenced, or combined, including, but not limited to, a single discovered rule, a single trend description, or a single relationship statement.

The term “description information” refers to human-readable text or equivalent expressions generated from internal representation information and configured to explain the corresponding knowledge information in natural language or a similar format.

The term “prompt sentence information” refers to information representing an input instruction for a generative information processing model, including, but not limited to, natural language sentences, paragraphs, or structured messages that describe a task, context, or constraints.

The term “generation-instruction information” refers to a portion of the prompt sentence information that explicitly or implicitly indicates a requested operation of the generative information processing model, including, but not limited to, a request to generate proposals, summaries, or explanations.

The term “generative information processing model” refers to a parameterized computational model configured to generate text or other information in response to input data, including, but not limited to, a neural network-based language model or other generative model trained on large-scale data.

The term “text generation processing” refers to processing in which a generative information processing model outputs a sequence of characters, tokens, or symbols forming natural language text or similar expressions based on input information.

The term “idea information” refers to information that expresses one or more proposals, concepts, or strategies derived from knowledge information and generated by a generative information processing model, including, but not limited to, business improvement plan information, measure plan information, product proposal information, and service proposal information.

The term “business improvement plan information” refers to idea information that specifies changes or optimizations to business operations, workflows, or policies, including, but not limited to, recommendations for process modification, resource allocation, or performance enhancement.

The term “measure plan information” refers to idea information that specifies concrete actions or measures to address identified issues or opportunities, including, but not limited to, campaign plans, procedural measures, and control measures.

The term “product proposal information” refers to idea information that specifies characteristics, positioning, or configuration of goods or offerings proposed for a market, including, but not limited to, product features, target segments, and pricing suggestions.

The term “service proposal information” refers to idea information that specifies characteristics, content, or provision methods of services proposed for users or customers, including, but not limited to, service packages, support offerings, and delivery channels.

The term “display device” refers to an apparatus configured to output visual information to a user, including, but not limited to, a monitor, a touch screen, a mobile device display, or a head-mounted display.

The term “operation information” refers to information indicating user operations performed through an input interface, including, but not limited to, clicks, selections, text inputs, and control commands.

The term “evaluation information” refers to information indicating a user's assessment of generated idea information or system behavior, including, but not limited to, ratings, scores, labels, comments, or selection of evaluation categories.

The term “additional prompt sentence information” refers to prompt sentence information directly or indirectly provided by a user in addition to automatically generated prompt sentence information, including, but not limited to, free-form text requests and additional constraints.

The term “correspondence relationship” refers to an association stored by the system that links two or more items of information, including, but not limited to, a mapping between evaluation information, prompt sentence information, and idea information.

The term “processing conditions” refers to parameters, rules, or configurations that control behavior of data analysis processing or prompt generation processing, including, but not limited to, model selection, threshold values, feature sets, and template structures.

The term “constraint condition information” refers to information representing one or more restrictions, scopes, or requirements to be applied to generation or analysis, including, but not limited to, target business domain information, target period information, target group information, and output format information.

The term “target business domain information” refers to information specifying an application area or category of business activities for analysis or generation, including, but not limited to, marketing, sales, operations, or customer support.

The term “target period information” refers to information specifying a temporal range to which analysis or generation is directed, including, but not limited to, a start time, an end time, or a discrete period such as a quarter or a season.

The term “target group information” refers to information specifying a subset of entities to be considered in analysis or generation, including, but not limited to, customer segments, geographic regions, organizational units, or demographic groups.

The term “output format information” refers to information specifying a desired structure, style, or representation of generated output, including, but not limited to, a number of items, section layout, bullet list format, or narrative format.

The term “analysis-purpose information” refers to information indicating a goal or objective of a particular analysis or generation task, including, but not limited to, promotion planning, cost reduction, risk mitigation, or product design support.

In one embodiment, a server, a terminal, and a communication network cooperate to implement the claimed system. The server includes at least one processor, a main memory, a non-volatile storage device such as a solid-state drive, and a network interface. The terminal includes an input device, a display device, a memory, and a communication interface. The server executes a program stored in the non-volatile storage device to cause the processor to perform data collection, data analysis processing, knowledge extraction, prompt sentence generation, generative AI model invocation, and presentation of idea information.

The server uses a general-purpose operating system, such as a server-oriented operating system, and executes application software implemented in a high-level programming language such as Python. The server uses a database management system, such as a relational database, to store structured data, and optionally uses a document-oriented database to store internal representation information and log information. The server uses libraries such as a numerical computation library and a data frame processing library for data preprocessing and feature extraction, and uses a machine learning framework, such as a tensor-based deep learning framework or an array-based deep learning framework (e.g., frameworks of the type commonly known as TensorFlow or PyTorch), to construct and train machine learning models. The server further accesses a generative AI model via an external or internal model-serving interface, for example through an HTTP-based API.

The server collects business-related document information, record information, and structured data information transmitted from the terminal. The user operates the terminal to select files such as spreadsheet files, text documents, or log exports, and the terminal transmits these files to the server using a secure communication protocol such as HTTPS. The server receives the files, verifies their integrity, and stores the raw files in the non-volatile storage device. The server also registers metadata, including file type, upload time, and originating user identifier, in the relational database. In one embodiment, the server further collects streaming log data from external systems via a message queue or streaming platform, and stores the incoming data records in a structured table in the database.

The server performs data preprocessing as part of the data analysis processing. The server uses a data frame processing library to load structured data from the relational database and to parse semi-structured text formats. The server normalizes date formats, converts character encodings, handles missing values by applying imputation strategies such as mean substitution or forward filling, and removes corrupted records by applying validation rules. The server converts categorical fields such as product categories, regions, or customer segments into encoded integer or one-hot vector representations using preprocessing functions. The server also performs time-series alignment by resampling transaction records into fixed time intervals, thereby creating regular sequences suitable for time-series models.

The server extracts features from the preprocessed data. For transactional data, the server computes aggregate statistics such as total sales per time window, average purchase frequency per customer, and distribution of product categories. For customer-related data, the server derives features such as recency, frequency, and monetary value, and encodes demographic attributes into numerical vectors. For business document information, the server may apply natural language preprocessing using tokenization and term frequency computations, and may derive document embeddings using a pre-trained language model running locally on the server or via an inference service. These features are stored in intermediate data structures in main memory and optionally serialized to disk for reuse.

The server performs machine learning on the extracted features. In one embodiment, the server constructs a time-series forecasting model using a recurrent neural network architecture, such as a long short-term memory (LSTM) network. The server defines a model comprising an input layer that accepts sequences of numerical features, one or more LSTM layers with specified hidden-state dimensions, and a fully connected output layer that produces a prediction of future demand or sales. The server initializes model weights using a standard weight initialization method, defines a loss function such as mean squared error, and uses an optimization algorithm such as stochastic gradient descent or an adaptive gradient method to update the weights. The server iteratively trains the model by feeding batched training sequences, computing gradients of the loss with respect to model parameters, and updating the parameters according to the optimization rule until convergence criteria are reached.

In another embodiment, the server constructs a clustering model, such as a k-means clustering model, to segment customers or products based on the extracted features. The server initializes cluster centroids, iteratively assigns data points to the nearest centroid according to a distance metric such as Euclidean distance, and recomputes centroids until the total within-cluster variance converges below a threshold. The server thus obtains cluster labels, which represent latent patterns in customer behavior or product affinities.

The server converts outputs of these models into knowledge information. For the time-series model, the server compares predicted values across time windows and identifies significant trend information, such as consistent increases in predicted demand during specific months or days of the week. The server applies statistical tests or threshold-based rules to classify a change as a trend, for example, by requiring that the average predicted value during a target period exceeds a baseline period by a predetermined percentage. For the clustering model, the server characterizes each cluster by computing aggregate statistics of feature values within the cluster, such as mean age, preferred product categories, and average order value, and identifies pattern information such as “cluster A comprises high-frequency, low-value customers preferring basic products.”

The server stores the resulting knowledge information as internal representation information structured in units of knowledge. In one embodiment, the server represents each unit of knowledge as a record comprising fields for a pattern identifier, a human-readable label, a formal rule or condition, an associated metric (e.g., confidence or support), and references to underlying data segments. The server stores these records in a knowledge table in the relational database or in a document collection in a document store. The server maintains indices on fields such as business domain, time range, and target group to enable efficient retrieval of knowledge units relevant to a particular analysis-purpose.

The server generates description information from the internal representation information. The server applies template-based natural language generation rules, in which placeholders in a sentence pattern are filled with values from the knowledge record. For example, for a knowledge unit indicating that sales of a particular product increase by a certain percentage in a specific season among a particular age group, the server generates a sentence of the form “Product X shows a Y % increase in sales in season Z among customers in group G.” The server may apply grammatical rules to handle pluralization and formatting. The server thus produces human-readable text that accurately reflects the structured knowledge information.

The server constructs prompt sentence information by combining the description information with generation-instruction information and constraint condition information. The server retrieves multiple relevant knowledge units from the knowledge store based on the user-specified analysis-purpose information, such as planning a promotion for the next quarter. The server assembles a prompt in which the description information is listed as bullet points or enumerated items, followed by instructions specifying a requested type of output, target business domain, target period, target group, and desired output format. For example, the server may create a prompt sentence such as:

“The following knowledge has been extracted from our customer purchase history data:
1. Product B shows a 30% increase in sales each spring among customers aged 20-29.
2. Customers in this age group frequently purchase Product B together with energy drinks and snack items.
3. Online sales via social media ads show a 20% higher conversion rate than email campaigns for this segment.

Based on this knowledge, act as a marketing strategist and propose detailed, actionable promotion strategies for the next spring season.

Please specify:
target subsegments within the 20-29 age group,
recommended marketing channels (e.g., specific social media platforms),
campaign concepts and key messages,
discount structures and bundle offers, and
expected qualitative impact.
   Return the answer in clear, structured paragraphs.”

The server may also process a user-provided prompt sentence and combine it with internal description information. For example, the user may input at the terminal: “Based on our customer purchase history for the last two years, including seasonal variations, generate three concrete promotion plans for the coming winter. Each plan should specify target customer segments, key messages, marketing channels, and an estimated impact on sales.”

The terminal transmits this text to the server, and the server integrates this user-provided request as part of the generation-instruction information, appending internally generated description information ahead of or within the same prompt string.

The server transmits the constructed prompt sentence information to a generative AI model. In one embodiment, the generative AI model is implemented as a transformer-based language model having multiple attention layers, feed-forward layers, and normalization layers. The model receives the prompt as a sequence of token identifiers, processes them through a stack of transformer decoder blocks, computes attention weights over previous tokens to capture context, and outputs probability distributions over the vocabulary for subsequent tokens. The server sets parameters such as temperature, top-k, and maximum token length to control the diversity and length of the generated text. The server then samples or selects tokens according to these distributions to produce the generated response text.

The server receives the generated text from the generative AI model and interprets it as idea information. The server optionally parses the generated text to identify segments corresponding to business improvement plan information, measure plan information, product proposal information, or service proposal information. The server may apply rule-based parsers or pattern matching to identify headings, bullet lists, or key-value structures, and may assign scores or categories to the output segments.

The server presents the idea information to the user via the terminal. The terminal receives the generated content in a structured response and renders it via the display device, using a graphical user interface implemented, for example, with a web framework on the client side. The terminal may show the original description information, the constructed prompt sentence, and the generated idea information together so that the user can understand the relationship. The user can scroll through the content, expand or collapse sections, and save or export the idea information through operations on the terminal.

The server acquires evaluation information and operation information from the user through the terminal. The user may indicate that a particular generated idea is useful or not useful, assign a multi-level rating, or input free-text comments. The terminal transmits this evaluation information, along with identifiers of the corresponding prompt sentence and knowledge units, to the server. The server records the correspondence relationship between evaluation information, prompt sentence information, and idea information in a feedback table. The server uses this correspondence relationship to adjust processing conditions. For example, if ideas generated from certain types of knowledge units consistently receive low evaluations, the server may lower the priority of these knowledge units in future prompt construction or adjust threshold values used to select patterns and trends.

The server may also adapt the template structures used in prompt generation based on feedback. If prompts that include detailed constraint condition information produce more highly rated outputs, the server may increase the granularity of constraint descriptions, such as specifying narrower target groups or more explicit output formats. The server may apply a reinforcement learning-like adjustment, where prompts and internal configurations associated with positive feedback are favored in future sessions.

In terms of technical effects, the described architecture improves the functioning of the computer as an information processing apparatus. By converting heterogeneous raw data into structured knowledge units and then using these units to systematically drive a generative AI model, the server reduces redundant or inefficient data processing and avoids repeated ad hoc manual interpretation. The use of explicit internal representation information and indexed knowledge stores allows the server to reuse previously extracted patterns, thereby reducing the computational load associated with repeating full-scale model training or raw analysis for similar tasks. The constraint condition information embedded in prompt sentence information allows the server to control the generative AI model so that irrelevant or overly generic outputs are reduced, thereby improving output precision and reducing the need for repetitive user corrections.

The server's machine learning modules also provide technical improvements. For example, by using time-series models tailored to transaction sequences, the server can perform more accurate detection of seasonal trends than simple aggregate comparisons, thereby reducing false positives and improving the quality of knowledge information. The server can employ regularization techniques, such as dropout in neural network layers and L2 weight penalties, to prevent overfitting, and can use mini-batch training to improve computational efficiency on large datasets. The server may use early stopping criteria based on validation loss, thus minimizing unnecessary training epochs and saving computation time and energy.

Furthermore, the feedback-driven adaptation of processing conditions provides a non-trivial technical advantage. The server uses structured feedback to automatically adjust data selection, feature weighting, and prompt template choice, which changes the behavior of the system in a way that a static rule-based pipeline cannot achieve. This yields improved convergence towards prompt formulations and analysis configurations that are empirically effective, enhancing both speed and accuracy of subsequent idea generation tasks. The system therefore goes beyond merely automating a human analyst's workflow and instead introduces a computer-specific feedback loop that tunes low-level processing parameters and template structures.

In additional embodiments, the server may be configured to operate with alternative model architectures. For instance, the server may apply gradient-boosted decision trees for pattern detection in tabular data, or may use an autoencoder to compress high-dimensional feature spaces and detect anomalies. The resulting latent representations or anomaly scores are then converted into knowledge units according to predefined rules. The generative AI model may also be deployed locally on the server hardware, instead of being accessed through an external service, with weights stored on the non-volatile storage device and inference executed directly on the processor or on a dedicated accelerator. This local deployment can reduce network latency and improve throughput, thereby further enhancing processing speed.

In yet another embodiment, multiple servers may be used in a distributed configuration. A first server may handle data ingestion and preprocessing, a second server may execute machine learning training and inference, and a third server may manage knowledge storage and prompt generation. These servers may communicate via a secure internal network, and the modularization of roles can improve scalability and fault tolerance. Load balancing across servers can be employed to handle large volumes of requests from multiple terminals without degrading response time.

Through these configurations and data flows, the system provides a concrete technical solution that improves how a computer stores, analyzes, and utilizes business-related information. The server implements specific data structures for knowledge units, employs non-trivial model architectures and training methods, and uses structured prompt generation and adaptive feedback mechanisms to control a generative AI model. As a result, the system achieves improvements such as increased processing speed by reusing structured knowledge, higher accuracy in identifying relevant patterns and trends, reduced computational and communication load through selective pattern retrieval, and reduced error in generated idea information through constraint-aware prompt sentences. These effects arise from the particular arrangement and interaction of the server, terminal, data processing modules, knowledge representation, and generative AI model, and thus constitute an improvement in computer technology itself.

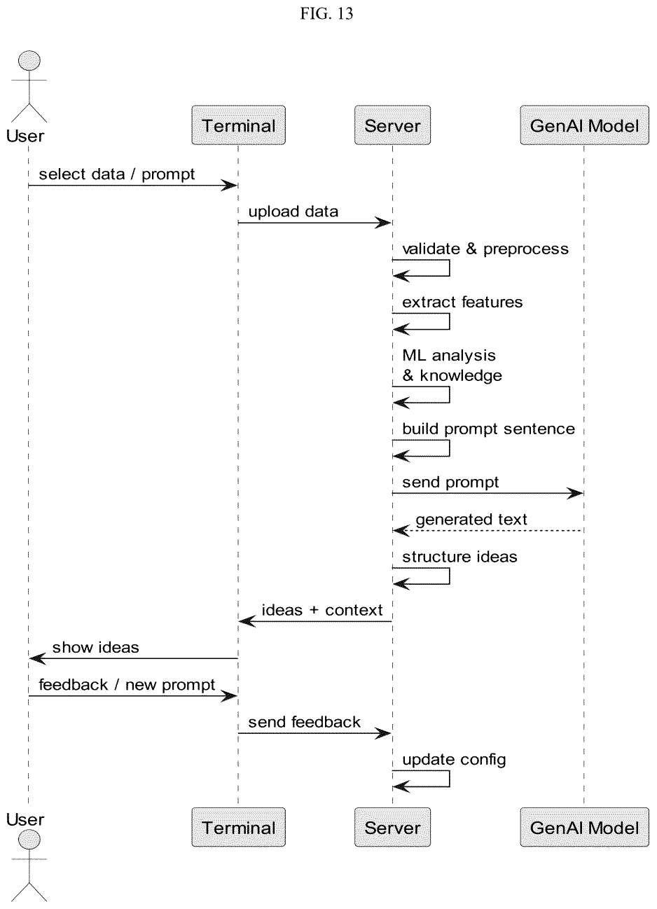

The following describes the processing flow using FIG. 13.

### Step 1:

The terminal presents a data selection and upload interface to the user.

The user selects input files including business-related document information, record information, and structured data information, such as spreadsheet files, log files, and text reports.

The terminal transmits the selected files and associated metadata (file name, file type, user identifier, timestamp) to the server via a secure communication protocol.

The input of this step is one or more business-related data files and metadata provided by the user through the terminal.

The output of this step is a set of raw data files and metadata received and stored by the server in a storage device.

### Step 2:

The server validates the received files and registers them in a storage device.

The server checks file integrity, verifies file types and sizes against predefined criteria, and discards or flags corrupted or unsupported files.

The server stores accepted raw files in non-volatile storage and writes corresponding metadata records into a relational database.

The input of this step is the raw data files and metadata transmitted from the terminal.

The server performs data validation and file system operations to assign storage paths, create database records, and index identifiers.

The output of this step is a set of validated raw data files persisted in storage and corresponding metadata entries in the database.

### Step 3:

The server performs data preprocessing on the stored data.

The server loads structured data from the database and parses semi-structured files, normalizing date formats, converting character encodings, handling missing values, and removing invalid records according to validation rules.

The server encodes categorical fields into numerical representations and aligns time-series records into regular intervals for later analysis.

The input of this step is the validated raw data and metadata stored in the storage device and database.

The server executes data frame operations and type conversions to transform heterogeneous raw data into cleaned and normalized data structures.

The output of this step is a set of preprocessed data tables and sequences stored as in-memory data structures and optionally as intermediate files.

### Step 4:

The server performs feature extraction to transform preprocessed data into analytical feature sets.

The server computes aggregate statistics such as totals, averages, frequencies, and ratios, and derives additional features such as recency, frequency, and monetary value for customers or products.

The server represents text-based document information as numerical vectors using techniques such as bag-of-words, term frequency measures, or pre-computed embeddings.

The input of this step is the preprocessed data structures produced in Step 3.

The server applies arithmetic operations, aggregations, and encoding algorithms to convert domain-level records into feature vectors suitable for machine learning.

The output of this step is one or more feature matrices and associated labels or time indices stored in memory or as serialized feature datasets.

### Step 5:

The server executes machine learning processing on the feature sets.

The server trains models such as time-series neural networks or clustering models by feeding the feature matrices into a machine learning framework and updating model parameters based on a defined loss function.

The server evaluates trained models on validation data and applies the models to generate predictions, cluster labels, or other analytical outputs.

The input of this step is the feature matrices and, when applicable, target values or labels derived from historical data.

The server performs matrix multiplications, gradient calculations, and parameter updates to fit model parameters and then computes model outputs for the entire dataset.

The output of this step is a set of model outputs, including predicted values, cluster assignments, and model evaluation metrics.

### Step 6:

The server extracts knowledge information from the machine learning outputs.

The server analyzes predicted values over time to identify significant trends and detects recurring patterns in cluster assignments or association relationships.

The server applies threshold rules, statistical tests, or rule-mining algorithms to filter and formalize these patterns into structured knowledge units.

The input of this step is the model outputs generated in Step 5 and related contextual data.

The server performs comparisons, aggregations, and rule generation to transform raw model outputs into higher-level pattern information and trend information.

The output of this step is a collection of structured knowledge units stored as internal representation information in a knowledge store.

### Step 7:

The server generates human-readable description information from the knowledge units.

The server applies template-based sentence generation or rule-based text formatting to convert structured fields of each knowledge unit into natural language statements.

The server ensures that each description faithfully represents the underlying pattern or trend with explicit numeric values and conditions where applicable.

The input of this step is the internal representation information of knowledge units obtained in Step 6.

The server performs string formatting, placeholder substitution, and optional grammatical adjustments to map structured data into explanatory text.

The output of this step is a set of human-readable descriptions corresponding to the knowledge units.

### Step 8:

The server constructs prompt sentence information for a generative AI model.

The server selects multiple description texts relevant to a user-specified analysis-purpose, and combines them with generation-instruction statements and constraint condition information such as target business domain, target period, target group, and desired output format.

The server assembles these elements into a continuous prompt sentence or multi-paragraph instruction that conforms to the input format expected by the generative AI model.

The input of this step is the description information from Step 7 and analysis-purpose information, including any user-provided instructions.

The server performs string concatenation, ordering, and insertion of control phrases to form a coherent, task-specific prompt sentence.

The output of this step is a complete prompt sentence ready to be submitted to the generative AI model.

### Step 9:

The server transmits the prompt sentence to the generative AI model and obtains generated text.

The server sends the prompt sentence as tokenized input to a transformer-based language model via an API or local inference interface, specifying generation parameters such as temperature and maximum token length.

The server receives the generated token sequence from the model, converts tokens back to text, and records the raw generated output.

The input of this step is the constructed prompt sentence produced in Step 8.

The server executes network communication or local inference calls, model forward passes, and token sampling operations to generate a text response.

The output of this step is a generated text corresponding to idea information produced by the generative AI model.

### Step 10:

The server structures and classifies the generated text as idea information.

The server analyzes the generated text to detect sections, headings, bullet lists, and key phrases, and assigns labels indicating whether segments correspond to business improvement plans, measures, product proposals, or service proposals.

The server may assign internal identifiers and confidence scores to each segment based on pattern matching and rule-based parsing.

The input of this step is the raw generated text obtained in Step 9.

The server performs text segmentation, pattern recognition, and categorization to transform unstructured generated text into structured idea information records.

The output of this step is a structured set of idea information entries suitable for storage and presentation.

### Step 11:

The server sends the structured idea information to the terminal for display.

The server packages the idea information, associated knowledge descriptions, and the original prompt sentence in a response format, and transmits the package to the terminal through a network interface.

The terminal receives the response, parses the structured data, and renders the idea information, descriptions, and context on the display device using a graphical user interface.

The input of this step is the structured idea information and related context data generated in Step 10.

The server performs serialization and communication operations to deliver the data, and the terminal performs parsing and drawing operations to display the information to the user.

The output of this step is a visual presentation of the idea information on the display device for user review.

### Step 12:

The user reviews the presented idea information and provides feedback or additional instructions.

The user reads the displayed ideas, selects evaluation options such as usefulness ratings, and may input additional prompt sentences or comments requesting refinement or alternative proposals.

The terminal captures these user interactions and sends evaluation information, operation information, and any new prompt sentences back to the server.

The input of this step is the displayed idea information and related context shown on the terminal.

The user performs cognitive evaluation and interaction actions, which are converted by the terminal into structured feedback messages.

The output of this step is a set of feedback data and additional instructions transmitted from the terminal to the server.

### Step 13:

The server records feedback and updates processing conditions.

The server stores the correspondence between evaluation information, the associated prompt sentence, and the generated idea information in a feedback database.

The server analyzes accumulated feedback to adjust processing conditions, including selection thresholds for knowledge units, weights for different feature types, and templates used for constructing prompt sentences.

The input of this step is the feedback data and additional instructions received from the terminal in Step 12.

The server performs database insertions, statistical aggregation, and rule updates to modify future behavior of data analysis and prompt generation modules.

The output of this step is an updated configuration state that influences subsequent executions of the data analysis pipeline and prompt sentence generation, thereby enhancing the quality and relevance of future idea information.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented decision support systems that utilize machine learning or generative artificial intelligence models typically process business data in a monolithic and static manner. In many such systems, numerical data and textual data are not jointly normalized and structured in a way that allows downstream models to consistently capture relationships between process metrics and human experience. As a result, analysis outputs are often noisy, difficult to interpret, and poorly suited as context for prompting generative artificial intelligence models. This leads to prompt sentences that are generic, weakly constrained, and highly dependent on manual tuning by expert users.

Furthermore, known systems generally treat generative artificial intelligence models as black-box text generators: they accept a user-provided instruction and return free-form text, without an intermediate layer that systematically incorporates prior analytical results, historical adoption feedback, and user-specific constraints. Because the construction of prompts is not dynamically adapted based on feedback and past effectiveness, the quality, relevance, and implementability of generated proposals remain inconsistent. The computing resources of the underlying data processing and model inference pipeline are therefore used inefficiently, and users must repeatedly iterate and manually refine prompts, which increases latency and reduces throughput of the overall system.

In addition, conventional systems rarely incorporate user emotional state as a first-class input into the technical pipeline that governs data analysis and prompt construction. Even when emotion recognition is present, it is usually implemented as a separate user interface feature and is not tightly integrated into the logic that determines the number of outputs, the tone of responses, and the difficulty level of proposed actions. This lack of integration prevents the system from adaptively modulating generative model behavior in response to measurable user context, and thus limits the ability of the computer system to optimize interaction flows, reduce cognitive load, and improve user engagement.

Moreover, most existing architectures do not provide a closed feedback loop in which user adoption decisions and evaluations of generated items are systematically collected, structured, and reinjected into the prompt generation logic. Without such structured feedback, the system cannot learn which types of prompt patterns yield high-utility results and cannot automatically evolve its prompt templates or constraints. This absence of an adaptive, feedback-driven prompt generation layer results in a static configuration that quickly becomes suboptimal as the environment, data distributions, and user preferences change.

Accordingly, there is a need for an improved computer-implemented system that: (i) integrates heterogeneous task-related information into a unified representation, including both numerical signals and structured experience or knowledge extracted from text; (ii) applies trained analysis models to derive bottleneck information, relationship information, and improvement candidates as machine-usable context; (iii) automatically constructs constraint-rich prompt sentences for generative artificial intelligence models by combining analytical results, user requests, and stored adoption history; (iv) dynamically modulates prompt construction based on automatically estimated user emotional state; and (v) updates prompt generation rules over time using structured feedback, thereby improving the technical performance, stability, and usefulness of the end-to-end data processing and generation pipeline executed by the processor.

The specific processing by the specific processing unit 290 of the data processing device 12 in Application Example 2 is realized by the following means.

The present invention provides a server comprising a processor configured to acquire task-related information from at least one storage medium and at least one external apparatus, to store the task-related information as integrated data, to preprocess numerical information included in the integrated data by executing an information processing program to remove abnormal values and perform normalization, to process textual information included in the integrated data by using natural language processing to perform segmentation, feature extraction, and topic extraction so as to structure the textual information as experience information and knowledge information, to apply at least one trained analysis model to the preprocessed numerical information and the structured experience information or knowledge information to generate an analysis result including bottleneck information of a process, relationship information, and improvement candidate information, to automatically generate a prompt sentence, as an instruction sentence to be given to a generative artificial intelligence model, based on the analysis result, a request content received from a user, and stored adoption history information and evaluation information, and to add constraint conditions including a requested number of outputs, a representation format, and a level of detail of explanation to the prompt sentence, to transmit the prompt sentence to the generative artificial intelligence model, to obtain a generation result including improvement proposal information, concept information, or suggestion information from the generative artificial intelligence model, to divide the generation result into items and classify the items based on a type, an ease of execution, and a priority, to output the classified generation result to a terminal device, to store adoption information and evaluation information acquired from the terminal device as stored information, and to update generation rules of the prompt sentence based on the adoption information and the evaluation information. This enables the computer system to implement a technically improved, closed-loop data processing and generation pipeline in which heterogeneous task-related data are jointly normalized and structured, analytical models produce stable machine-usable context, prompt sentences for generative artificial intelligence models are automatically and adaptively constrained based on context and user emotion, and feedback-driven updates to prompt generation rules enhance the precision, relevance, and efficiency of generated outputs while reducing manual tuning and computational waste.

The term “task-related information” refers to information associated with execution, monitoring, or management of one or more tasks, including but not limited to numerical data, textual data, log data, and document data generated by devices, applications, or users in a work process.

The term “storage medium” refers to any physical medium capable of storing digital information, including but not limited to semiconductor memory, magnetic storage, optical storage, and network-accessible storage.

The term “external apparatus” refers to any apparatus or system located outside a server that can provide data or receive data via a communication interface, including but not limited to sensor systems, control systems, user terminals, and external information systems.

The term “integrated data” refers to a data set obtained by aggregating, aligning, and storing heterogeneous pieces of task-related information from one or more sources in a unified data structure or schema.

The term “numerical information” refers to portions of task-related information that are represented as numerical values, such as measurements, counts, performance indicators, timestamps converted to numeric form, and other quantitative attributes.

The term “textual information” refers to portions of task-related information that are represented as character strings or natural language sentences, including but not limited to memos, reports, logs, comments, and descriptive fields.

The term “information processing program” refers to software instructions executable by a processor that perform operations on data, including but not limited to filtering, normalization, transformation, and feature extraction.

The term “abnormal values” refers to data values that deviate from expected ranges or patterns according to predetermined rules or statistical criteria, and that are treated as noise or outliers for purposes of analysis.

The term “normalization” refers to data transformation processing that maps numerical information into a standardized range or distribution, such as scaling, standardization, or other transformations that facilitate analysis by machine learning models.

The term “natural language processing” refers to computational techniques for analyzing and processing textual information written in human languages, including but not limited to tokenization, part-of-speech tagging, parsing, and semantic analysis.

The term “segmentation” refers to processing that divides textual information into units such as tokens, words, sentences, or phrases suitable for subsequent analysis.

The term “feature extraction” refers to processing that derives representative attributes or metrics from raw data, including but not limited to keyword extraction, term frequency calculation, embedding generation, and syntactic or semantic feature computation.

The term “topic extraction” refers to processing that identifies one or more latent topics or themes present in textual information using methods such as clustering, topic modeling, or classification.

The term “experience information” refers to structured data representing recurring patterns, procedures, or behaviors observed in past tasks, derived from textual information and indicating practical knowledge gained through experience.

The term “knowledge information” refers to structured data representing concepts, rules, relationships, or insights extracted from textual information, including but not limited to best practices, guidelines, and domain-specific understanding.

The term “trained analysis model” refers to a computational model obtained by a training process using example data, such as a machine learning model or statistical model, that is configured to analyze input data and output analysis results.

The term “analysis result” refers to data generated by the trained analysis model that represents derived information about the integrated data, including but not limited to bottleneck information, relationship information, and improvement candidate information.

The term “bottleneck information” refers to information indicating one or more portions of a process or system that limit performance, throughput, or efficiency relative to other portions.

The term “relationship information” refers to information indicating correlations, dependencies, or causal relationships between variables, events, or entities present in the integrated data.

The term “improvement candidate information” refers to information that suggests potential changes, adjustments, or actions that may improve performance, quality, or efficiency of a process or system.

The term “prompt sentence” refers to a natural language instruction sentence provided as input to a generative artificial intelligence model to guide generation of output content.

The term “instruction sentence” refers to a sentence or set of sentences expressing a command, request, or constraint given to a generative artificial intelligence model, and is implemented as a prompt sentence in the system.

The term “generative artificial intelligence model” refers to an artificial intelligence model configured to generate new content, such as text, based on input data including a prompt sentence, by learning patterns from training data.

The term “request content” refers to information indicating a user's intention, question, or desired output, including but not limited to a task description, a query, or a goal specification input by a user.

The term “adoption history information” refers to information that records whether past generation results were adopted, implemented, or utilized by users, including associated conditions and context.

The term “evaluation information” refers to information representing assessments or ratings of generation results by users or systems, such as usefulness scores, satisfaction levels, or qualitative feedback.

The term “constraint conditions” refers to parameters or requirements associated with a prompt sentence that restrict or shape the behavior of the generative artificial intelligence model, including but not limited to number of outputs, representation format, and level of detail.

The term “requested number of outputs” refers to a constraint condition that specifies how many distinct items, proposals, or responses the generative artificial intelligence model is requested to produce.

The term “representation format” refers to a constraint condition that specifies a structural or stylistic form for output, such as a list, table, bullet points, or narrative text.

The term “level of detail of explanation” refers to a constraint condition that specifies the desired depth or granularity of descriptive information in the generated output.

The term “generation result” refers to content produced by the generative artificial intelligence model in response to a prompt sentence, including but not limited to proposals, concepts, and suggestions.

The term “improvement proposal information” refers to portions of the generation result that describe specific actions or modifications intended to improve a process, system, or outcome.

The term “concept information” refers to portions of the generation result that describe abstract ideas, models, or high-level approaches, rather than concrete implementation steps.

The term “suggestion information” refers to portions of the generation result that provide recommended directions, options, or considerations for a user.

The term “item” refers to a discrete element obtained by partitioning the generation result, such as a single proposal, concept, recommendation, or action.

The term “type” refers to a classification attribute assigned to an item, indicating a category such as process change, tool change, organizational change, product idea, or service idea.

The term “ease of execution” refers to an attribute indicating a relative difficulty level for implementing an item, considering factors such as required resources, time, and complexity.

The term “priority” refers to an attribute indicating a relative order or importance assigned to an item for consideration or implementation.

The term “terminal device” refers to a computing device used by a user to interact with the system, including but not limited to a workstation, portable terminal, smart glasses device, or other user interface device.

The term “stored information” refers to data retained in one or more storage media by the server, including adoption information, evaluation information, and historical analysis or generation data.

The term “generation rules of the prompt sentence” refers to rules, templates, or parameters used by the processor to construct prompt sentences, including logic for selecting context, constraints, and phrasing.

The term “emotional state” refers to a state representing a user's emotion at a point in time, such as stress, joy, neutrality, or other affective conditions, estimated from sensor input.

The term “image information” refers to data representing images or video frames captured by an imaging device, such as a camera, associated with the user or environment.

The term “acoustic information” refers to data representing sound signals captured by an audio input device, such as a microphone, including speech and non-speech audio.

The term “tone of expression” refers to a stylistic characteristic of language used in output, such as formal, casual, reassuring, or encouraging tone.

The term “difficulty of execution” refers to a characterization of how challenging it is to carry out a proposed item, taking into account user capability, required changes, and operational impact.

The term “product information” refers to information describing one or more goods that can be offered to a user, including attributes such as features, categories, and usage.

The term “service information” refers to information describing one or more services that can be offered to a user, including attributes such as content, conditions, and procedures.

The term “candidate” refers to an item selected or generated as a possible option from product information or service information for presentation to a user.

The term “prioritization” refers to processing that assigns an order or ranking to candidates based on one or more criteria, including emotional state and adoption history information.

In one embodiment, a server, a terminal, and a user cooperate to implement the claimed system. The server is realized by a computing device including at least one central processing unit, a main memory, a nonvolatile storage device, and a network interface. The server executes programs stored in the nonvolatile storage device and loaded into the main memory. The terminal is realized by a user device such as a workstation, a portable terminal, or a head-mounted display device including a display unit, an image sensor, a microphone, and a communication interface. The user operates the terminal to provide requests and feedback.

The server stores, in the nonvolatile storage device, a data management module, a preprocessing module, a natural language processing module, an analysis module, a prompt generation module, a generative AI interaction module, a classification module, a feedback management module, and an emotion integration module. The server also stores trained parameters of at least one analysis model and at least one generative AI model interface configuration. The terminal stores a user interface module and a sensor control module for capturing image information and acoustic information related to the user.

The server acquires task-related information from one or more storage media and external apparatuses. The server connects to a database management system implemented on local or remote storage, and issues structured queries to retrieve numerical logs, transactional records, and textual documents. The server also connects, via a network interface, to external apparatuses such as sensor controllers, production line controllers, and external information systems, and receives data streams in structured formats such as comma-separated values or JavaScript object notation. The server stores the acquired data as integrated data in a data store using a unified schema, for example with tables representing time series records, event records, and text records linked by task identifiers.

The server preprocesses numerical information included in the integrated data using the preprocessing module. The server loads numerical fields into internal arrays and applies normalization processing such as min-max scaling or z-score standardization to each feature dimension. The server detects abnormal values by comparing each value to statistical thresholds derived from interquartile ranges or standard deviations and either removes, clips, or flags these values in the data structure. This preprocessing yields stabilized input distributions for subsequent analysis models, which reduces numerical instability and improves convergence behavior of machine learning inference.

The server processes textual information included in the integrated data using the natural language processing module. The server performs tokenization to split sentences into tokens, performs part-of-speech tagging to annotate tokens with grammatical roles, and performs lemmatization to convert token variants into base forms. The server computes features such as term frequency-inverse document frequency vectors, word embeddings, and sentence embeddings. The server applies topic extraction by executing an algorithm such as probabilistic topic modeling or clustering on the embedding space to obtain topic identifiers and topic weight distributions for each document. The server then generates structured experience information and knowledge information by associating topics, key phrases, and document identifiers into records representing summarized experiences and knowledge. This structuring allows the subsequent analysis module to treat text-derived features as machine-usable vectors aligned with numerical features.

The server applies at least one trained analysis model to the preprocessed numerical information and the structured experience information or knowledge information. In one embodiment, the server uses a neural network model including an input layer, multiple fully connected hidden layers with nonlinear activation functions, and an output layer generating bottleneck scores and improvement scores for process segments. The server concatenates normalized numerical features and text-derived topic features into a joint feature vector, and feeds the vector into the analysis model. The server computes outputs representing bottleneck information, relationship information, and improvement candidate information. The server stores these outputs as analysis results in a structured form, such as a table in which each row corresponds to a process step with associated bottleneck scores, importance weights, and suggested improvement areas.

The server trains the analysis model in advance on historical integrated data. The server defines a loss function such as a weighted sum of mean squared error for predicted metrics and cross-entropy loss for classification labels representing known bottlenecks. The server performs iterative optimization using a gradient-based algorithm such as stochastic gradient descent or a variant with adaptive learning rate. The server updates model weights based on computed gradients, and uses validation data sets to prevent overfitting by applying techniques such as early stopping or regularization. By jointly learning from numerical and text-derived features, the analysis model captures relationships that are not directly apparent from either modality alone, providing improved accuracy and robustness compared to simpler rule-based or single-modality approaches.

The server automatically generates a prompt sentence, as an instruction sentence to be given to a generative AI model, based on the analysis result, a request content received from the user, and stored adoption history information and evaluation information. The server stores prompt templates in the nonvolatile storage device, each template specifying a textual structure with placeholders for contextual data such as bottleneck descriptions, improvement candidate summaries, and constraints. The server selects a template based on the domain of the task and the type of requested output, and fills the placeholders with the analysis result and the request content. The server further inspects the adoption history information and evaluation information to estimate which types of prompts have historically led to outputs with high adoption rates or favorable evaluations. The server adjusts elements of the prompt sentence such as requirement wording, explicitness of constraints, and requested output structure based on this feedback.

The server adds constraint conditions including a requested number of outputs, a representation format, and a level of detail of explanation to the prompt sentence. For example, the server appends explicit instructions such as “Provide exactly two concise suggestions in bullet list form” or “Explain each proposal in three sentences, including rationale and estimated impact.” By encoding these constraints in the prompt sentence, the server controls the behavior of the generative AI model at a fine-grained level, which reduces ambiguity, shortens the generated text to an appropriate length, and improves computational efficiency by limiting unnecessary tokens.

The server transmits the prompt sentence to the generative AI model via the generative AI interaction module. In one embodiment, the server communicates with a remote generative AI service over a network through an application programming interface, sending the prompt sentence and configuration parameters such as maximum output length and randomness level. In another embodiment, the generative AI model is implemented locally on the server as a neural network having a transformer architecture, including an embedding layer, multiple attention layers, and output layers that generate token probabilities. The server decodes output tokens into a natural language text that constitutes the generation result.

The server obtains the generation result including improvement proposal information, concept information, or suggestion information from the generative AI model and divides the generation result into items. The server uses the classification module to detect item boundaries based on sentence delimiters, list markers, or explicit numbering in the text. The server assigns each item a type, such as process modification, resource change, or training suggestion, based on keyword patterns and similarity measures in the embedding space. The server estimates an ease of execution for each item by combining information such as required resource categories, estimated implementation time, and similarity to past adopted items. The server assigns a priority attribute based on a scoring function that integrates importance scores from the analysis result and the estimated ease of execution. By converting unstructured generative output into structured items with attributes, the server facilitates downstream filtering and ranking operations that can be performed efficiently and reproducibly.

The server outputs the classified generation result to the terminal device. The server formats the items and associated attributes into a data structure suitable for the terminal's user interface. The server transmits this data via the network interface. The terminal receives the data, and the user interface module displays the items with visual indicators corresponding to type, ease of execution, and priority. The user can select, comment on, or reject individual items. The terminal captures user actions as adoption information and evaluation information and transmits these back to the server.

The server stores the adoption information and evaluation information as stored information. The feedback management module aggregates this stored information to compute statistics such as adoption rates by item type, typical reasons for rejection inferred from comments, and correlations between prompt patterns and outcome quality. The server periodically updates generation rules of the prompt sentence by adjusting template selection criteria, phrasing patterns, and constraint configurations, using these statistics. In one example, if the server detects that prompts requesting a small number of highly actionable items produce higher adoption rates than prompts requesting many generic ideas, the server changes the default requested number of outputs in subsequent prompt sentences. This feedback-driven update mechanism improves the technical performance of the prompt generation process over time.

The terminal estimates an emotional state of the user based on image information and acoustic information. The terminal uses the image sensor to capture facial images and uses the microphone to capture voice signals while the user interacts with the system. The terminal executes an emotion estimation algorithm, which may include a convolutional neural network applied to facial images and a recurrent or transformer-based network applied to voice features. The terminal extracts features such as facial landmarks, facial action units, pitch, energy, and spectral coefficients, and feeds these features into the emotion estimation model. The terminal obtains an emotional state label and a confidence value and transmits this information to the server.

The server integrates the emotional state into the prompt generation process. The emotion integration module adjusts multiple prompt parameters based on the emotional state. For example, when the emotional state indicates stress, the server reduces the requested number of outputs, requests simpler phrasing, and prioritizes low-effort suggestions. When the emotional state indicates high engagement or joy, the server requests more exploratory or ambitious proposals. Because the server uses the emotional state as a parameter in a deterministic algorithm that modifies the prompt sentence and its constraints, the integration of emotion is not merely a user interface enhancement but a technical factor that directly influences computational workload, token generation patterns, and ranking behavior of the generative AI model, leading to reduced cognitive overload and improved system responsiveness.

The server uses concrete prompt sentence examples to illustrate this behavior. In one scenario, the server constructs a prompt sentence:

“You are an expert in manufacturing process improvement. The following analysis results describe bottlenecks in the assembly line for product A.

Bottlenecks:
1) The screw tightening step has an average delay of 20%.
2) The final inspection step causes frequent rework.

Extracted know-how: Technicians report that tool changeovers during screw tightening are slow, and lighting at the inspection station is insufficient.

The user is currently under high stress and has limited time.

Based on this information, propose two concrete, low-effort improvement ideas that can be implemented within one month. Use a concise and reassuring tone.”

In another scenario, the server generates a prompt sentence for new product ideation:

“Generate five innovative product concepts for compact, eco-friendly home appliances suited to small city apartments. Use the following customer feedback and market trend summary as context: [summary]. For each concept, include a short description and three key features.”

In yet another scenario, the server generates a prompt sentence for emotion-aware customer support: “A customer appears stressed and is browsing wellness products. Based on our product catalog summary and typical preferences of stressed office workers, propose three suitable products and write a gentle, non-intrusive sales phrase for each.”

The server also generates a prompt sentence for internal communication: “The team has successfully completed Project X and users are feeling joyful. Generate a short, upbeat announcement to share this success with the whole company, emphasizing collaboration and future opportunities.”

By using structured analysis results and emotion information to construct these prompt sentences, the server shapes the generative AI model's outputs in a controlled manner and reduces the need for manual intervention.

The server can employ different neural network architectures for the generative AI model and the analysis model. In one variation, the analysis model is a recurrent neural network tailored for time series of process metrics, supporting long-term dependency capture through gated recurrent units. In another variation, the analysis model uses gradient boosted decision trees on engineered statistical features derived from numerical and text-derived features. In yet another variation, the generative AI model is implemented as a smaller transformer network deployed locally, with a reduced number of layers to match resource constraints. These variants enable adaptation to different computational environments while preserving the core pipeline structure.

The server achieves technical effects that go beyond mere automation of human reasoning. By jointly normalizing and structuring heterogeneous data, the server improves data alignment for machine inference, which reduces misclassification and numerical error. By integrating analysis results, adoption history, and emotional state into prompt construction, the server changes system behavior at the level of data structures and algorithmic control flow, thereby improving calculation efficiency and relevance of outputs. For example, targeted requests for a limited number of high-value items reduce the number of generated tokens, lower network bandwidth usage, and reduce latency. In addition, the feedback-driven update of prompt generation rules allows the system to converge to prompt patterns that statistically yield higher accuracy and adoption rates, which constitutes an improvement in the functioning of the computer system itself.

The terminal and the server can be configured in multiple alternative embodiments. The terminal can be a head-mounted display device capturing continuous video and overlaying suggestions in the user's field of view. The server can be implemented as a cluster of computing nodes with distributed data storage and parallelized preprocessing, enabling scaling to large volumes of task-related information. The emotion estimation can be performed either on the terminal for low-latency estimation or on the server using more complex models, with the choice depending on resource availability and privacy requirements. The generative AI model can be accessed as a remote service or deployed on-premises as a compressed model optimized for specific hardware accelerators.

Because the server decomposes generative outputs into structured items with clearly defined attributes, and because the server adaptively controls prompt generation through technical parameters derived from analysis and feedback, the system transforms raw task-related data into machine-optimized context and structured proposals with improved precision and efficiency. This architecture, and the specific combination of modules and data flows, provide a technical solution to the problems of unstable quality, inefficient resource usage, and static configuration in conventional generative AI-based systems.

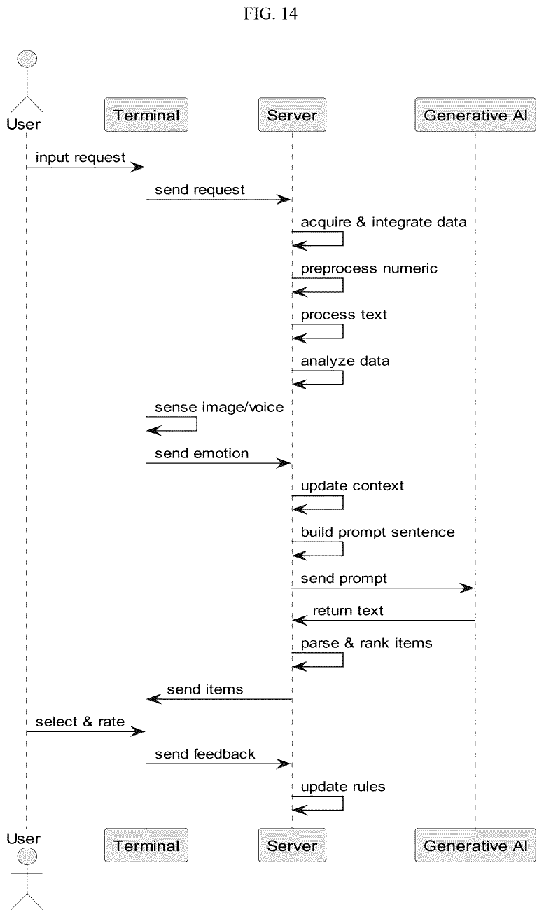

The following describes the processing flow using FIG. 14.

### Step 1:

Server acquires task-related information from storage media and external apparatuses.

Server receives as input one or more data sources, including database tables, log files, sensor streams, and document repositories. Server issues structured queries to a database management system and sends protocol messages to external apparatuses such as controllers and sensors. Server converts heterogeneous records (for example, process logs, numeric measurements, and text reports) into a unified internal data structure with fields such as task identifier, timestamp, numeric feature vector, and text field. Server outputs integrated data stored in a session-specific dataset.

### Step 2:

Server preprocesses numerical information in the integrated data.

Server receives as input the integrated data containing raw numerical fields such as counts, durations, and measured values. Server applies data cleaning operations, including removal of duplicate records and detection of abnormal values by comparing each numeric element to statistical thresholds (for example, values deviating by more than a specified number of standard deviations). Server performs normalization by scaling each numeric feature dimension using a selected method such as min-max scaling or standardization. Server outputs a cleaned and normalized numerical dataset, where each record is represented by a stable, dimension-aligned feature vector suitable for model input.

### Step 3:

Server processes textual information in the integrated data using natural language processing.

Server receives as input the integrated data containing text fields such as reports, comments, and logs associated with tasks. Server performs tokenization to split each text field into tokens, applies part-of-speech tagging and lemmatization to normalize words, and computes features such as term frequency-inverse document frequency vectors and embeddings. Server executes topic extraction algorithms to group documents into topics and to assign topic weight distributions to each document. Server outputs structured experience information and knowledge information, where each document is mapped to topic identifiers, key phrases, and vector representations stored in structured tables.

### Step 4:

Server generates joint feature vectors for analysis.

Server receives as input the normalized numerical dataset and the structured experience information and knowledge information. Server aligns records by task identifier and timestamp and concatenates numerical feature vectors with text-derived feature vectors (for example, topic weights or embeddings) into joint feature vectors. Server performs optional dimensionality reduction or feature selection to remove redundant features. Server outputs a joint feature matrix where each row corresponds to a task instance and each column corresponds to a selected feature.

### Step 5:

Server applies a trained analysis model to generate analysis results.

Server receives as input the joint feature matrix. Server feeds each joint feature vector into a trained analysis model such as a neural network or tree-based model. Server computes intermediate layer activations and final outputs that represent bottleneck scores for process segments, relationship scores between variables, and improvement candidate scores. Server aggregates these outputs across records to identify consistently high-scoring bottlenecks and strong relationships. Server outputs structured analysis results including bottleneck information, relationship information, and improvement candidate information, stored in tables indexed by process step, variable pair, or candidate identifier.

### Step 6:

Terminal estimates an emotional state of the user.

Terminal receives as input image information from an image sensor and acoustic information from a microphone while the user interacts with the system. Terminal extracts visual features such as facial landmarks and action units, and audio features such as pitch, energy, and spectral coefficients. Terminal feeds these features into an emotion estimation model stored locally or accessed via a remote service. Terminal computes an emotional state label (for example, stress, joy, neutral) and an associated confidence value. Terminal outputs emotional state data and transmits it to the server together with a session identifier.

### Step 7:

Server updates session context with emotional state and historical information.

Server receives as input the analysis results from Step 5, the emotional state data from Step 6, and stored adoption history information and evaluation information associated with the current user or similar tasks. Server updates a session context record by setting fields such as current emotional state, preferred number of outputs, and preferred tone. Server computes statistics from the adoption history and evaluation information to estimate which types of suggestions and prompt structures have yielded successful outcomes. Server outputs an updated session context object that will guide prompt construction.

### Step 8:

Server constructs a context-rich prompt sentence for the generative AI model.

Server receives as input the analysis results, the updated session context, and a request content provided by the user (for example, a brief description of the desired task or question). Server selects a prompt template based on task type and user profile and populates placeholders with concrete information such as identified bottlenecks, summarized know-how, and explicit constraints. Server modulates constraint conditions (requested number of outputs, representation format, and level of detail) according to the emotional state and the success patterns inferred from adoption history. Server outputs a fully constructed prompt sentence, for example: “You are an expert in manufacturing process improvement. The following analysis results describe bottlenecks in the assembly line for product A. Bottlenecks: [list]. Extracted know-how: [summary]. The user is currently under high stress and has limited time. Based on this information, propose two concrete, low-effort improvement ideas that can be implemented within one month. Use a concise and reassuring tone.”

### Step 9:

Server transmits the prompt sentence to the generative AI model and obtains a generation result.

Server receives as input the constructed prompt sentence and configuration parameters such as maximum length and randomness level. Server sends the prompt sentence to a generative AI model via an application programming interface or executes a local generative AI model using the prompt sentence as input. Server performs tokenization and encoding of the prompt sentence, initiates inference in the generative AI model, and decodes output token probabilities into text. Server outputs a generation result comprising natural language text that includes improvement proposal information, concept information, or suggestion information.

### Step 10:

Server divides the generation result into items and assigns attributes.

Server receives as input the generation result text. Server parses the text using rule-based and natural language processing methods to identify boundaries between proposals, concepts, or suggestions, for example by detecting list markers, numbering, or sentence boundaries. Server creates items for each detected segment of text. Server analyzes each item's content to determine a type (for example, process modification, resource change, training action), estimates an ease of execution using heuristics and similarity to previously adopted items, and computes a priority score by combining analysis result weights and ease-of-execution values. Server outputs a structured list of items with associated attributes type, ease of execution, and priority.

### Step 11:

Server outputs structured items to the terminal and stores feedback-related identifiers.

Server receives as input the structured item list and the session context. Server formats the items into a data structure suitable for the terminal's user interface, including labels, descriptions, and numeric attributes. Server transmits this formatted data to the terminal via the network interface and records identifiers linking items to the current session in a feedback table. Server outputs confirmation that the structured items and identifiers have been stored for later feedback processing.

### Step 12:

Terminal presents items to the user and collects adoption and evaluation information.

Terminal receives as input the structured items and their attributes from the server. Terminal renders each item on the display with visual cues corresponding to type, ease of execution, and priority. Terminal presents interactive controls that allow the user to accept, reject, comment on, or rate each item. User observes the presented items, selects some items for adoption, enters comments, and optionally assigns evaluation scores. Terminal records the user's actions as adoption information and evaluation information linked to item identifiers and the session identifier. Terminal outputs this feedback data and sends it back to the server.

### Step 13:

Server updates stored information and adjusts prompt generation rules.

Server receives as input the adoption information and evaluation information from the terminal. Server writes this feedback into persistent storage as part of adoption history information and evaluation information, indexed by item identifiers, prompt pattern identifiers, and user or task attributes. Server computes updated statistics such as adoption rates by item type and by prompt configuration, and measures correlations between emotional state and acceptance of suggestions. Server modifies generation rules of the prompt sentence by updating parameters in template selection logic, constraint defaults, and phrasing preferences based on these statistics. Server outputs updated rule parameters that will be applied during subsequent executions of Step 8.

### Step 14:

User applies adopted items in a target environment and optionally triggers further sessions.

User receives as input the adopted items and their descriptions via the terminal. User performs real-world actions or configures external apparatuses (for example, adjusting machine settings or modifying procedures) according to the accepted proposals. After observing outcomes, user may initiate another session with the server by submitting new request content summarizing changed conditions. User outputs new input information that becomes part of the integrated data in Step 1, thereby closing the loop between system processing and real-world effects.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

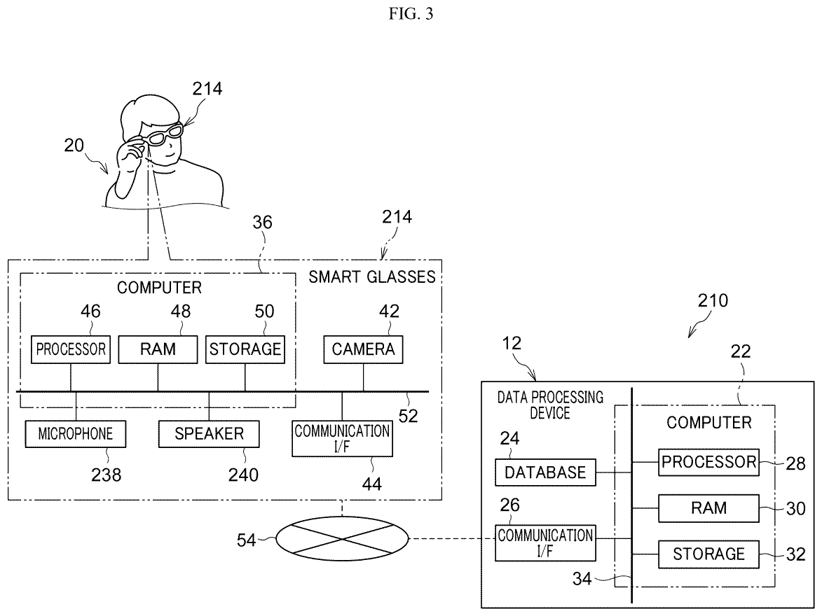

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

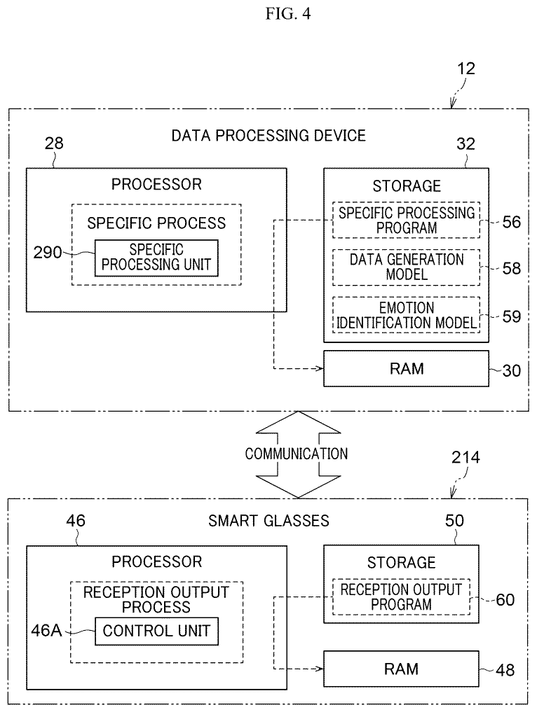

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

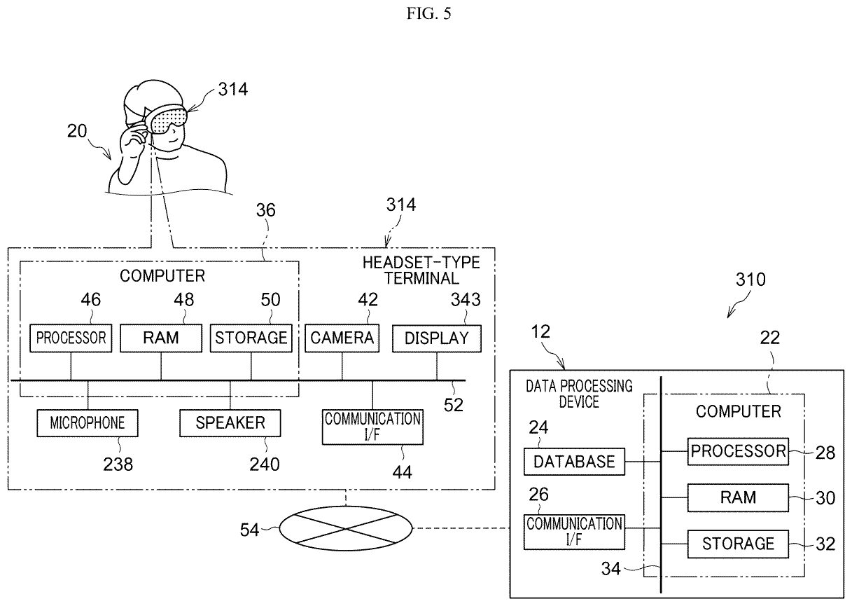

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

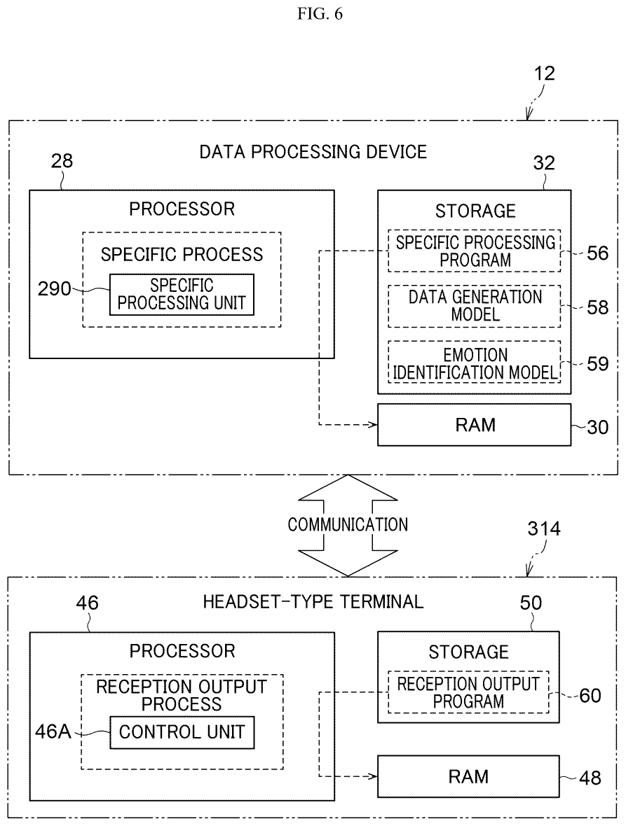

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

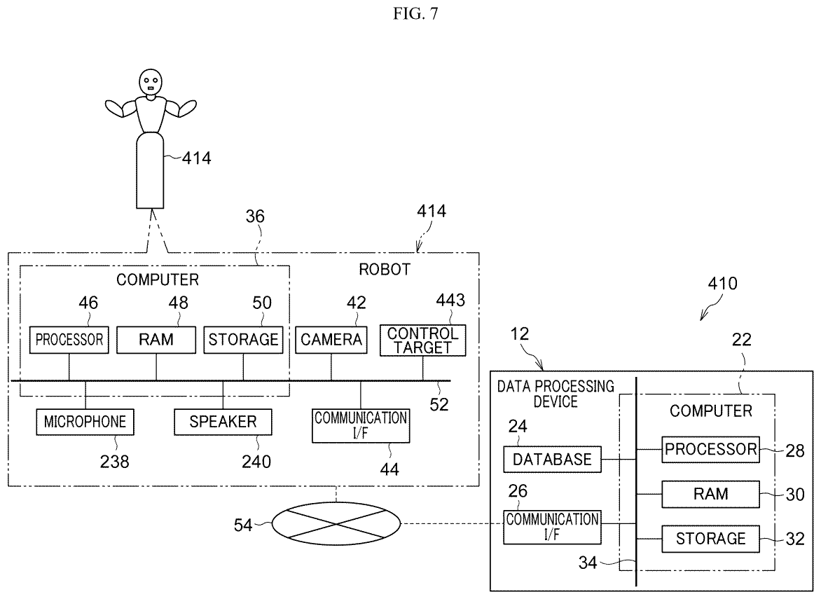

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

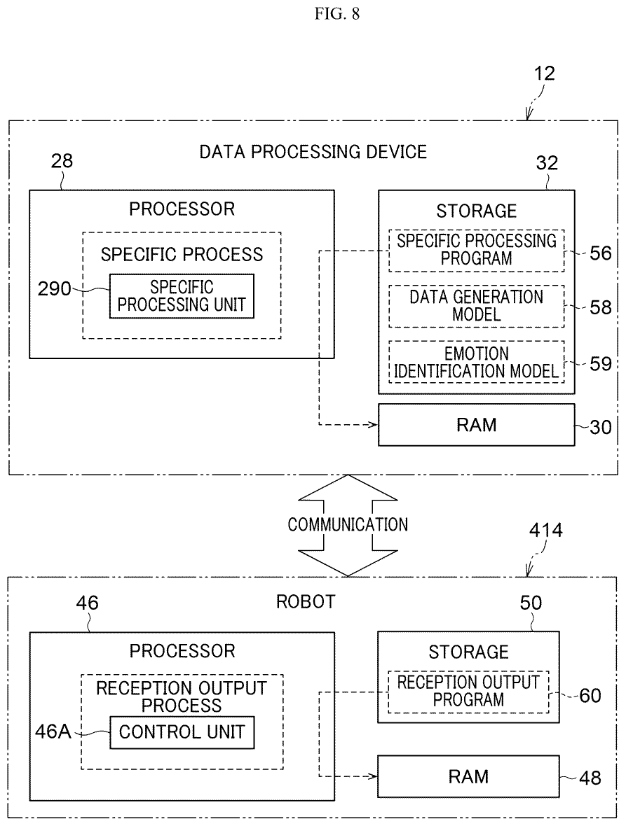

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

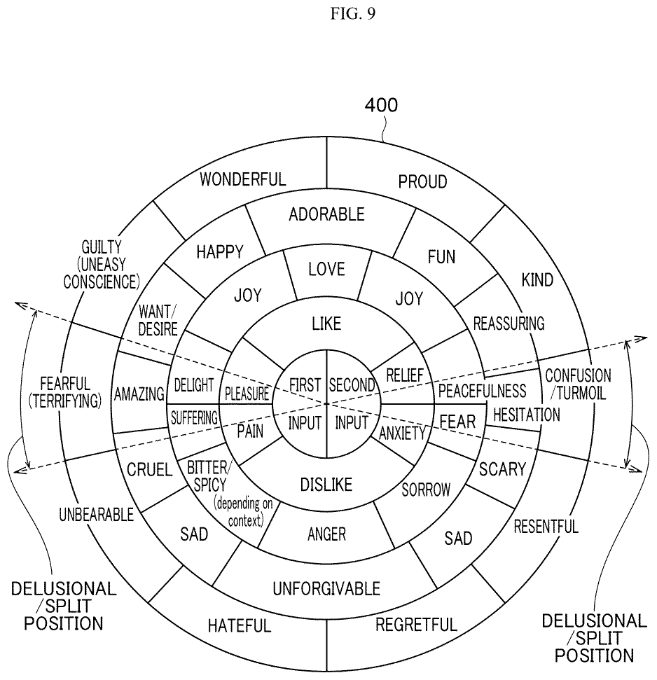

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

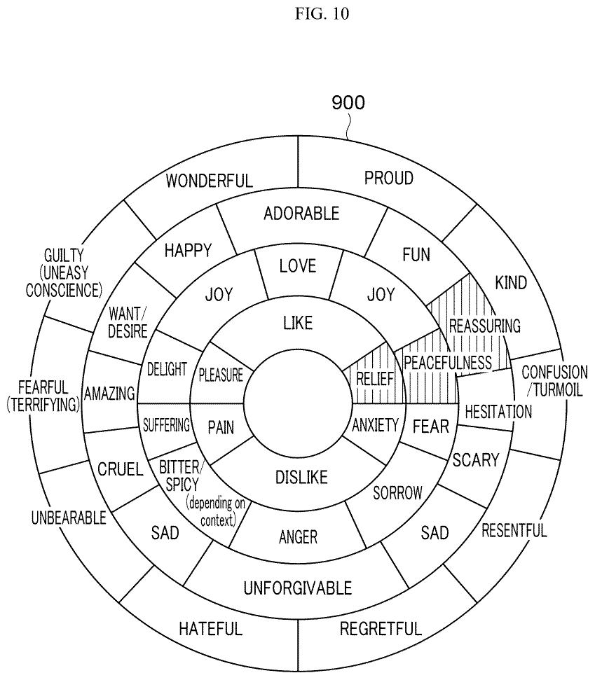

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### EXAMPLE 1

### (Supplementary 1)

A system comprising a processor,
wherein the processor is configured to
acquire structured data and unstructured data from a plurality of information sources including business-related information, and to normalize and preprocess the acquired data,
perform natural language processing on the preprocessed unstructured data, including morphological analysis, lexical extraction, and expression normalization, and extract keywords and phrases indicating experiential information and knowledge information related to execution of business tasks,
generate a feature matrix based on the extracted keywords and phrases and quantitative information included in the structured data, and perform clustering processing on the feature matrix by using a machine learning algorithm to derive pattern information and trend information correlated with outcomes of the business tasks,
generate, from the pattern information and the trend information, structured analysis results including novel insight information indicating success factors and risk factors of the business tasks,
construct a prompt sentence that, by using the structured analysis results as input data, instructs a generative AI model to generate, in a natural language, at least one of a summary of the analysis results, an explanation of causal relationships, and proposals for improvement of the business tasks, and input the prompt sentence into the generative AI model, and
obtain a report sentence in the natural language output from the generative AI model, and generate report information that is configured to be output to a user terminal based on the report sentence.

### (Supplementary 2)

The system according to supplementary 1,
wherein the processor is configured to
receive instruction information including analysis conditions and analysis viewpoints from a user, dynamically change content of the prompt sentence and a target data set for the clustering processing based on the instruction information, and generate a prompt sentence that instructs the generative AI model to perform re-analysis.

### (Supplementary 3)

The system according to supplementary 1,
wherein the processor is configured to
extract, for each of a plurality of clusters obtained by the clustering processing, representative keywords, representative business attributes, and representative outcome indicators, generate summary information including the representative keywords, the representative business attributes, and the representative outcome indicators, and add the summary information to the prompt sentence so as to instruct the generative AI model to generate, in the natural language, novel insights and concrete action proposals related to the business tasks.

### Application Example 1

### (Supplementary 1)

A system comprising a processor,
wherein the processor is configured to
acquire, from an external apparatus and a recording medium, information related to operations executed within an organizational entity, and store the acquired information as integrated data including measurement values and historical information indicating operation states of production equipment, and text information describing contents of maintenance work,
perform string analysis on the text information included in the integrated data, and execute natural language processing including morphological analysis and part-of-speech classification to extract terms indicating a maintenance target element, a sign of abnormality, and a countermeasure, and convert the extracted terms into structured knowledge as standardized labels including a component category, a symptom category, and a treatment category,
generate time-series features and categorical features on the basis of the measurement values included in the integrated data and the structured knowledge, and create a training data set in which the features are associated with presence or absence of future failure occurrence,
construct, by using a statistical learning algorithm or a neural network, a prediction model configured to output a failure occurrence probability of the production equipment during a predetermined future period, by using the training data set as input, and store the prediction model in a storage area,
input, to the constructed prediction model, features based on latest measurement values acquired from the production equipment in operation and the structured knowledge, and generate an analysis result including a failure risk index and a preventive maintenance candidate for each production equipment,
embed analysis data summarizing the analysis result as additional information into a prompt sentence to be used as input text to a generative artificial intelligence model, and generate the prompt sentence that instructs the generative artificial intelligence model to generate findings having unexpectedness regarding a preventive maintenance plan or a measure for improving operation efficiency, and
acquire a response output from the generative artificial intelligence model, and output the response in association with the failure risk index and the preventive maintenance candidate to a display device or a notification device.

### (Supplementary 2)

The system according to supplementary 1,
wherein the processor is configured to
include a query sentence acquired from an input/output device operated by a user into the prompt sentence, and change a extraction range and a summary content of the analysis data in accordance with contents of the query sentence, thereby generating the prompt sentence adapted to an interest of each user.

### (Supplementary 3)

The system according to supplementary 1,
wherein the processor is configured to
compare a recommended maintenance action or an operation change plan included in the response output from the generative artificial intelligence model with operation schedule data of the production equipment, add evaluation information indicating feasibility and expected downtime to the recommended maintenance action or the operation change plan to reconfigure the response output, and present the reconfigured information to the user.

### EXAMPLE 2

### (Supplementary 1)

A system comprising a processor and a storage device,
wherein the processor is configured to
collect business-related document information, record information, and structured data information, and store the collected information in the storage device,
perform data analysis processing including data preprocessing, feature extraction, and machine learning on the business-related information stored in the storage device, and extract knowledge information including pattern information and trend information from the business-related information,
store the extracted knowledge information as internal representation information structured in units of knowledge,
convert the internal representation information into human-readable description information, generate prompt sentence information including the description information and generation-instruction information, and generate a prompt sentence that instructs input of the prompt sentence information into a generative information processing model,
cause the generative information processing model to perform text generation processing to generate idea information including new business improvement plan information, measure plan information, or concept plan information based on the prompt sentence information and the knowledge information, and
present the idea information to a user via a display device.

### (Supplementary 2)

The system according to supplementary 1,
wherein the processor is configured to
acquire operation information, evaluation information, or additional prompt sentence information from the user, record a correspondence relationship between the evaluation information and the prompt sentence information and the idea information, and update at least one of processing conditions of the data analysis processing and processing conditions of generation of the prompt sentence information based on the correspondence relationship.

### (Supplementary 3)

The system according to supplementary 1,
wherein the processor is configured to
generate prompt sentence information to which constraint condition information including target business domain information, target period information, target group information, and
output format information is automatically added, based on content of the knowledge information and analysis-purpose information designated by the user, and cause the generative information processing model to generate idea information including product proposal information or service proposal information specialized for a corresponding business domain by inputting the prompt sentence information including the constraint condition information to the generative information processing model.

### Application Example 2

### (Supplementary 1)

A system comprising a processor,
wherein the processor is configured to
acquire task-related information from a storage medium and an external apparatus and store the task-related information as integrated data,
preprocess numerical information included in the integrated data by executing an information processing program to remove abnormal values and perform normalization, and process textual information included in the integrated data by using natural language processing to perform segmentation, feature extraction, and topic extraction so as to structure the textual information as experience information and knowledge information,
apply a trained analysis model to the preprocessed numerical information and the structured experience information or knowledge information to generate an analysis result including bottleneck information of a process, relationship information, and improvement candidate information,
automatically generate a prompt sentence, as an instruction sentence to be given to a generative artificial intelligence model, based on the analysis result, a request content received from a user, and stored adoption history information and evaluation information, and add constraint conditions including a requested number of outputs, a representation format, and a level of detail of explanation to the prompt sentence,
transmit the prompt sentence to the generative artificial intelligence model, obtain a generation result including improvement proposal information, concept information, or suggestion information from the generative artificial intelligence model, and divide the generation result into items and classify the items based on a type, an ease of execution, and a priority, and
output the classified generation result to a terminal device, store adoption information and evaluation information acquired from the terminal device as stored information, and update generation rules of the prompt sentence based on the adoption information and the evaluation information.

### (Supplementary 2)

The system according to supplementary 1,
wherein the processor is configured to
estimate an emotional state of the user based on image information and acoustic information acquired from the terminal device, and, in the automatic generation of the prompt sentence, change at least one of the requested number of outputs, a tone of expression, and a difficulty of execution requested from the generative artificial intelligence model in accordance with the emotional state.

### (Supplementary 3)

The system according to supplementary 1,
wherein the processor is configured to
generate, based on the analysis result and the emotional state, a prompt sentence for causing the generative artificial intelligence model to select, from product information or service information, candidates to be presented to the user, and to perform prioritization on product candidates or service candidates obtained as the generation result by using the emotional state and the adoption history information, and present the product candidates or the service candidates to the terminal device in accordance with a result of the prioritization.

What is claimed is:

1. A system comprising:
circuitry configured to:
receive, via a communication interface coupled to a packet-switched network, structured data and unstructured data from a plurality of information sources, and normalize and preprocess the received data;
perform natural language processing on the preprocessed unstructured data comprising morphological analysis, lexical extraction, and expression normalization, and extract keywords and phrases indicating experiential information and knowledge information related to execution of tasks;
generate a feature matrix based on the extracted keywords and phrases and quantitative information included in the structured data, and perform clustering processing on the feature matrix using a machine learning algorithm to derive pattern information and trend information correlated with outcomes of the tasks;
generate structured analysis results comprising insight information indicating success factors and risk factors of the tasks from the pattern information and the trend information, and construct a prompt sentence that uses the structured analysis results as input data and instructs a generative neural network model to generate at least one of a summary of the analysis results, an explanation of causal relationships, and proposals for improvement, and transmit the prompt sentence to the generative neural network model via the communication interface; and
obtain a report sentence in natural language from the generative neural network model, generate report information based on the report sentence, and transmit the report information to a terminal device via the communication interface.

2. The system according to claim 1, wherein the circuitry is configured to receive instruction information comprising analysis conditions and analysis viewpoints from the terminal device via the communication interface, dynamically update the prompt sentence and a target data set for the clustering processing based on the instruction information, and retransmit the updated prompt sentence to the generative neural network model to obtain updated report information.

3. The system according to claim 2, wherein the circuitry is configured to store the instruction information, the updated prompt sentence, and the updated report information in a storage device in association with a session identifier, and to provide a revision history comprising the stored records to the terminal device upon request.

4. The system according to claim 2, wherein the circuitry is configured to apply a change detection function to identify the portion of the structured analysis results affected by the updated analysis conditions, and to limit the regeneration of the prompt sentence to the affected portion to reduce computational overhead.

5. The system according to claim 1, wherein the circuitry is configured to extract, for each of a plurality of clusters obtained by the clustering processing, representative keywords, representative task attributes, and representative outcome indicators, generate summary information comprising the representative keywords, the representative task attributes, and the representative outcome indicators, and add the summary information to the prompt sentence to instruct the generative neural network model to generate novel insights and action proposals related to the tasks.

6. The system according to claim 5, wherein the circuitry is configured to apply a cluster quality function to each cluster to compute a silhouette score, and to merge clusters whose silhouette scores fall below a threshold prior to generating the summary information to ensure that representative keywords reflect statistically stable patterns.

7. The system according to claim 5, wherein the circuitry is configured to store the representative keywords, representative task attributes, and representative outcome indicators in a storage device as a cluster profile library, and to augment the prompt sentence with historical cluster profiles retrieved from the cluster profile library to enable trend comparison across multiple clustering sessions.

8. The system according to claim 1, wherein the circuitry is configured to receive sensor data from the terminal device via the communication interface, analyze the sensor data to detect a user state, and adjust a content or format of the prompt sentence based on the detected user state prior to transmitting the prompt sentence to the generative neural network model.

9. The system according to claim 8, wherein the circuitry is configured to classify the detected user state into a plurality of predefined categories, apply a category-specific prompt template from a template library stored in a storage device, and substitute the category-specific prompt template into the prompt sentence to generate a personalized report request.

10. The system according to claim 8, wherein the circuitry is configured to store the detected user state and the associated report information in a storage device in association with a timestamp, and to compute a correlation metric between the user state and the report engagement patterns derived from interaction logs stored in the storage device.

11. The system according to claim 1, wherein the circuitry is configured to apply a feature selection function to the feature matrix to identify quantitative information features having the highest correlation with the outcomes of the tasks based on a variance importance score, and to reduce the feature matrix to a subset of high-importance features prior to performing the clustering processing.

12. The system according to claim 11, wherein the circuitry is configured to store the variance importance scores in a storage device in association with data source identifiers, and to apply a temporal decay function to the stored scores to reduce the weight of features derived from data sources that have not been updated within a configurable time window.

13. The system according to claim 1, wherein the circuitry is configured to apply a deduplication function to the keywords and phrases extracted from the preprocessed unstructured data to remove semantically equivalent entries prior to constructing the feature matrix, and to log the deduplicated entries in a storage device for subsequent vocabulary management.

14. The system according to claim 1, wherein the circuitry is configured to apply a natural language consistency validation function to the report sentence obtained from the generative neural network model to detect logical inconsistencies or unsupported factual claims, and to regenerate the prompt sentence with additional factual constraints when an inconsistency is detected.

15. The system according to claim 14, wherein the circuitry is configured to limit the consistency regeneration cycles to a maximum threshold, and to annotate the report information with a quality flag indicating that a maximum retry threshold was reached when the limit is exceeded, and to transmit the annotated report information to the terminal device.

16. The system according to claim 1, wherein the circuitry is configured to aggregate structured analysis results across a plurality of time periods stored in a storage device, apply a trend detection function to the aggregated results to identify longitudinal patterns, and include the longitudinal patterns as an additional input parameter in the prompt sentence.

17. The system according to claim 16, wherein the circuitry is configured to apply a seasonality decomposition function to the quantitative information included in the structured data prior to generating the feature matrix, separating trend components from seasonal components, and to store the decomposed components in the storage device for use in subsequent clustering sessions.

18. A system comprising:
circuitry configured to:
receive, via a communication interface coupled to a packet-switched network, structured data and unstructured data from a plurality of information sources, normalize and preprocess the data, and perform natural language processing comprising morphological analysis, lexical extraction, and expression normalization on the unstructured data to extract keywords and phrases;
generate a feature matrix from the extracted keywords, phrases, and quantitative information from the structured data, and perform clustering processing on the feature matrix using a machine learning algorithm to derive pattern information and trend information;
generate structured analysis results comprising insight information indicating success factors and risk factors from the pattern information and the trend information, extract representative keywords, representative task attributes, and representative outcome indicators for each cluster, and construct a prompt sentence incorporating the structured analysis results and the representative cluster information to instruct a generative neural network model to generate a report sentence;
receive instruction information from a terminal device via the communication interface, dynamically update the prompt sentence and a target data set for the clustering processing based on the instruction information, and retransmit the updated prompt sentence to the generative neural network model; and
obtain report information based on the report sentence or updated report sentence from the generative neural network model, and transmit the report information to the terminal device via the communication interface.

19. The system according to claim 18, wherein the circuitry is configured to apply a cluster quality function to compute a silhouette score for each cluster, merge clusters below a threshold, and apply a feature selection function to retain only high-importance features in the feature matrix prior to performing the clustering processing.

20. A method comprising:
receiving, via a communication interface coupled to a packet-switched network, structured data and unstructured data from a plurality of information sources, and normalizing and preprocessing the received data;
performing natural language processing on the preprocessed unstructured data comprising morphological analysis, lexical extraction, and expression normalization, and extracting keywords and phrases indicating experiential information and knowledge information related to execution of tasks;
generating a feature matrix based on the extracted keywords and phrases and quantitative information included in the structured data, and performing clustering processing on the feature matrix using a machine learning algorithm to derive pattern information and trend information;
generating structured analysis results comprising insight information indicating success factors and risk factors from the pattern information and the trend information, constructing a prompt sentence that uses the structured analysis results and instructs a generative neural network model to generate a report sentence, and transmitting the prompt sentence to the generative neural network model via a communication interface; and
obtaining the report sentence from the generative neural network model, generating report information based on the report sentence, and transmitting the report information to a terminal device via the communication interface.
